(19) United States
(12) Patent Application Publication
(10) Pub. No.: US 2020/0162266 A1
(43) Pub. Date: May 21, 2020

(54) FACILITATING ANALYTIC SERVICES FOR PROVENANCE OF DIGITAL DOCUMENTS

(71) Applicant: ADOBE INC., San Jose, CA (US)

(72) Inventors: Gavin Stuart Peter Miller, Los Altos, CA (US); Xuejun Xu, Cupertino, CA (US); Max Gray Edell, Ottawa (CA); John Bevil Bates, Highland, UT (US)

(21) Appl. No.: 16/193,759

(22) Filed: Nov. 16, 2018

(51) Int. Cl. H04L 9/32

(52) U.S. Cl. CPC H04L 9/3247; H04L 2209/38; H04L 9/3236

(57) ABSTRACT

Embodiments provide traceability of edits to a document, i.e., a verifiable and immutable provenance chain for the document. In particular, embodiments facilitate providing analytics services for a distributed ledger. In implementation, a unique identifier associated with a digital document can be received from a remote computing device. Based on the received unique identifier, it is determined that the distributed ledger includes a first transaction corresponding to a first transitioned state of the digital document and a second transaction corresponding to a second transitioned state of the digital document. Each transaction includes the unique identifier, a first fingerprint of the digital document generated at a first time of a transitioned state, and a second fingerprint of the digital document generated at a second time of a previously transitioned state. Thereafter, a provenance chain of the digital document including the first transaction followed by the second transaction is determined based on a determination that the second fingerprint of the second transaction corresponds to the first fingerprint of the first transaction.

### BACKGROUND

Technologies that enable difficult-to-detect alterations of digital assets (e.g., visual images, audio/video recordings, records of economic transactions, legal contracts, and such) are advancing. For example, conventional image editing applications enable editing of a digital image that modifies the visual appearance of a subject depicted within the image. The apparent body size and/or shape of a model depicted within an image may be altered and/or re-touched. Without examining an unmodified copy of the image, an observer of the edited image may be unable to visually perceive such alterations. Due to increasing concerns over body dysmorphic disorder issues correlated with the unrealistic portrayals of models in advertising, as well as other concerns, legislators in some jurisdictions have statutorily compelled the disclosure of some types of image alterations, particularly when used in advertising. The sophistication of these image editing applications make enforcement of such statutes difficult, at least because verifying that particular visual aspects of a digital image have not been altered is challenging.

In another example, scientists and engineers have developed deep learning methods that enable the alteration of an audio recording of a speaker, such that in the altered audio recording, the person appears to be speaking statements that were never uttered. The non-detectability of altering, within a digital document, an individual's visual appearance or speech (e.g., via “deepfake” machine learning technologies) gives rise to numerous concerns, including but not limited to issues related to deceptive advertising, copyright infringement, and fraud, among other things.

### SUMMARY

Embodiments of the present invention are directed to facilitating analytic services for provenance of a digital document. In particular, a chain of provenance associated with a digital document can be generated and utilized to facilitate improved analytics and auditability of changes made to the digital document. As described herein, document state data associated with a digital document, such as a digital fingerprint and/or edit logs associated with the digital document, can be stored on a distributed ledger. By traversing a distributed ledger having multiple records or transactions that each includes document state data corresponding to different states of a digital document, a chain of provenance associated with the digital document can be generated. Thereafter, the generated chain of provenance can be employed to facilitate auditability of changes made to the digital document. In other words, transactions stored on a distributed ledger and having related document state data stored thereon can be identified and analyzed to generate a provenance chain of a digital document, thereby facilitating the auditability of edits and/or alterations made to the digital document.

In operation, to generate a chain of provenance associated with a digital document, a unique identifier associated with the digital document can be used to search a distributed ledger having stored thereon digitally-signed transactions having digital fingerprints and edit histories corresponding to each determined state change of the digital document. Each stored digitally-signed transaction includes a digital fingerprint and edit history of the digital document, and references a prior digital fingerprint corresponding to a prior state of the digital document. Using the unique identifier, the distributed ledger is searched to identify digitally-signed transactions that each corresponds to various transitioned (e.g., modified) states of the digital document. Provided the identified transactions, a provenance chain of the digital document is generated such that each identified transaction, corresponding to a unique state of the digital document, is ordered in accordance with its edit history. In other words, for any particular state or “version” of a document, an auditable chain of edits to and from the particular state or version is determined and employed to generate a provenance chain associated with the digital document. The digital document provenance chain is employable to identify various states and/or edits made to a digital document, and can provide structured analytics data about the digital document and its provenance, which can also be provided for intuitive consumption (e.g., via a graphical user interface). In some implementations, generated digital document provenance chains can be employed to identify copies and/or similarities between two different digital documents, to detect potential copyright infringement, among other things.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is an exemplary system diagram of a distributed ledger network in accordance with some embodiments of the present invention;

FIG. 2 is a schematic depiction is provided illustrating an exemplary document provenance system in which some embodiments of the present invention may be employed;

FIG. 3 is a block diagram depicting an exemplary document editing application in accordance with some embodiments of the present invention;

FIG. 4 provides a block diagram depicting an exemplary image file format in accordance with some embodiments of the present invention;

FIG. 5 provides a block diagram that depicts an exemplary ledger analytics tool in accordance with some embodiments of the present invention;

FIG. 6A illustrates one embodiment of an enhanced process flow for managing various operations associated with a distributed ledger in accordance with some embodiments of the present invention;

FIG. 6B illustrates one embodiment of an enhanced process flow for providing various ledger analytics services in accordance with some embodiments of the present invention;

FIG. 6C illustrates another embodiment of an enhanced process flow for providing various ledger analytics services, in accordance with embodiments of the present invention; and

FIG. 7 is a block diagram of an exemplary computing environment suitable for use in implementing some embodiments of the present invention.

### DETAILED DESCRIPTION

The detectability of edits and/or alterations to digital assets or digital documents (e.g., digital images, audio/video recordings, records of economic transactions, and legal contracts) is important for various reasons, including but not limited to personal, reputational, health/wellness, economic, and legal concerns. The advent and increasing popularity of distributed ledgers has provided a means for storing verifiable data to a ledger, such as a blockchain, to ensure that records of varying transaction types can be stored immutably, without concerns of tampering or corruption. In this regard, distributed ledgers present a viable solution for tracking edits to digital assets or digital documents, due to the inherent assurances that the provenance of the digital asset or document cannot be altered, but remain easily auditable.

While distributed ledgers have become an increasingly popular medium for storing verifiable data, the tools for analyzing this data are generally lackluster. More specifically, block explorers are generally known as web-based tools for searching distributed ledgers. While block explorers can be ideal for searching records (e.g., transactions) stored on a distributed ledger, they typically fail to provide more than simple records-based results. A records-based search result generated based on a provided search parameter can be suitable for simple transactions, such as financial transactions between parties. However, provided that a digital document can have many different copies and varying versions therebetween, a simple records-based search result for records associated with a digital document would not be easy to decipher or consume. The generated search data would, in essence, be provided as raw results data that is difficult to traverse and even more difficult to understand. Moreover, to facilitate an improved technique for searching edits made to a document, or for determining when and where certain edits to a document took place, the organization of the provided results data would consume computing resources that could easily be mitigated with a more structured dataset, such as one that represents the entire provenance chain of a particular digital document.

As such, various embodiments herein are directed to facilitating analytic services for provenance of a digital document. In particular, a chain of provenance associated with a digital document or digital asset can be generated and utilized to facilitate improved analytics and auditability of changes made to the digital document. In this regard, the various embodiments provide a data structure, generated from records identified in a distributed ledger, that facilitates the traceability of any edits and/or alterations made to a digital document or asset, such as but not limited to digital images, digital audio/video recordings, digital records of transactions, electronic documents (e.g., PDF files, Word documents, text files), digital files (e.g., compressed documents, executable files, libraries, code files), and digital legal documents.

In operation, and at a high level, document state data stored by distributed ledger networks (e.g., peer-to-peer networks) can be searched and analyzed to generate a chain of provenance associated with a digital document. In particular, a unique identifier associated with the digital document can be used to search a distributed ledger having stored thereon digitally-signed transactions having digital fingerprints and edit histories corresponding to each determined state change of the digital document. The distributed ledger is searched to identify digitally-signed transactions that correspond to various transitioned (e.g., modified) states of the digital document. Using the identified transactions, a provenance chain of the digital document is generated such that each identified transaction, corresponding to a unique state of the digital document, is ordered in accordance with its edit history. In other words, for any particular state or “version” of a document, an auditable chain of edits to and from the particular state or version is determined and employed to generate a provenance chain associated with the digital document. Advantageously, the digital document provenance chain is employable to identify or recall various particular states of the document corresponding to the document's history, providing a verified provenance of edits (any and all edits) made to a document various states and/or edits made to a digital document, and/or determining a verifiable attribution for the contribution of various users engaged in the generation and/or editing of collaborative works.

### Overview

To provide traceability of alterations and/or edits to digital documents using distributed ledger technology (e.g., blockchain), a fingerprint of a document's state (e.g., a cryptographic hash of at least a portion of the document's contents) can be stored in a block (or record) within a distributed (i.e., non-centralized) ledger, such as a blockchain. The distributed ledger may be maintained via a distributed ledger network. The algorithm that generates the fingerprint of the document is sensitive to edits, alterations, and/or saved revisions of the document. For example, a cryptographic hashing algorithm that exhibits an avalanche effect when the contents of the document are altered may be employed to generate the document's fingerprint for each state of the document. Thus, when the fingerprint of a first state and a second state of the document are compared, a difference between the fingerprint of the first state and the fingerprint of the second state indicates at least an edit and/or alteration of the document.

The blocks of the distributed ledger may be cryptographically linked to ensure that the blocks (and thus the document-state fingerprints encoded in the blocks) are not retroactively alterable and/or corruptible upon being added to the ledger. Adding a block to the ledger requires a decentralized consensus amongst nodes storing the ledger. The decentralized consensus effectively verifies the cryptographic link to (and the un-corruptible and/or immutable integrity of the document-state fingerprints encoded in) the previous blocks. Thus, due to the decentralized nature of the ledger and the cryptographic links between the blocks, edits to the document are detectable (and thus traceable) via the document fingerprints encoded in the blocks. Accordingly, an edit history of the digital document is practically unalterable and verifiable, providing complete traceability of any and all edits and/or alterations made to the digital document. Because the ledger provides a provenance of the digital document or asset, the unalterable distributed ledger may be a blockchain-like provenance chain.

In various embodiments, implementations of the distributed ledger may be at least similar to a blockchain, and thus, once recorded into blocks of the distributed ledger, the contents of the ledger (i.e., the fingerprints of the various states of the documents) are practically unalterable, immutable, and/or incorruptible. Thus, the distributed ledger may be referred to throughout as a blockchain, though other forms of distributed ledgers known to those of ordinary skill remain within the purview of the present disclosure. The ledger may be additionally referred to as an immutable and/or non-corruptible database.

To enable traceability of an edit history, digital fingerprints corresponding with various states of a digital document are generated and stored in a distributed ledger. In this regard, a digital document, such as but not limited to a digital image, for which to provide traceability of an edit history is obtained or generated. For example, a camera may capture image data encoding the digital image. Upon obtaining the digital image (or other digital document or asset), a fingerprint (e.g., a cryptographic hash and/or hash value) of a first (e.g., an initial) state of the document is generated and added as a first block to a distributed ledger encoding the first state fingerprint of the document. In accordance with detecting a transition to a second state of the document (e.g., detecting a file operation, such as but not limited to editing, saving, re-saving, coping, and/or moving the document), and a fingerprint of the second state of the document is generated. A second block, encoding the second state fingerprint of the document, may be added to the distributed ledger, via a distributed consensus of nodes storing the ledger. In addition to a fingerprint of the second state of the document, the second block may include at least a fingerprint (e.g., a cryptographic hash) of at least a portion of the contents of the previous block in the chain (e.g., the first block), as well as a reference link back to the previous block. Because the contents of the previous block include a fingerprint of the document's previous state, the added block may include a fingerprint of a fingerprint, e.g., a hash value of a hash value. Throughout the document's history or lifetime, each state of the document may be detected and recorded in the ledger via the addition of additional blocks to the ledger. Thus, the fingerprints of each state (and thus indications of any edits to the contents) of the document are cryptographically linked in a chain (e.g., a blockchain).

As noted above, the second block includes at least the second state fingerprint of the document, a cryptographic hash of the contents of the first block (i.e., a hash value of the first state fingerprint of the document), and a reference link back to the first block. From the second block, the integrity of the contents of the first block may be verified via the reference link to the first block and the hash value of the contents of the first block. For example, the contents of the first block may be retrieved via the reference link and hashed via the same hashing algorithm originally employed to generate the hash value (of the contents of the first block) stored in the second block. A comparison of this hash value to the hash value stored in the second block may verify that the contents of the first block are unaltered and not corrupted. Thus, once a state fingerprint of the document has be entered into the ledger, any alterations to the fingerprint are detectable, and thus the fingerprint of the document is essentially unalterable, immutable, and/or non-corruptible. Due to the avalanche effect the algorithm employed to generate the state fingerprints of the document, a comparison between the first state fingerprint of the document and the second state fingerprint of the document may be employed to detect any edits or alterations made to the document between the first state of the document and the second state of the document. The integrity of each block may be similarly verified via traversing the chain of blocks in the ledger. Accordingly, any edits and/or alterations to the document are traceable via a traversal of the chain of unalterable blocks.

As such, embodiments described herein facilitate traceability and analytics associated with an edit history of a digital document or asset. In particular, an enhanced ledger analytics tool and/or application that is enabled to traverse the ledger can be utilized to verify or validate the integrity of the contents of ledger, and retrieve and provide any information included in the blocks of the ledger, including but not limited to the edit history of a document. In this regard, the enhanced analytics tool may be able to retrieve and/or recall any state of the document throughout the document's history or lifetime. The enhanced ledger analytics tool can provide a complete edit history (or provenance chain) for a document, as well as each state of the document. For example, in embodiments directed towards an image, via a p-hash algorithm described herein, a composite image may be analyzed so that subjects included therein are identified and extracted such that a corresponding p-hash is generated for each subject. Employing the enhanced tool, via traversing the ledger, the p-hash value of a particular subject could be searched to identify, among other things, an original image state and each subsequent image state. Via the user attribution included in the document's edit history, the enhanced tool may be employed to identify contributors of composite document, a percentage of attribution associated with user of (or contributor to) the composite document, and determination of copyright infringement and/or copyright owner. For example, a fingerprint based on a tamper resistant image hash function (e.g., a perceptual hash function) may be employed to detect whether two images are similar, even if one of the two images has been modified (e.g., rotated, scaled, or some other transformation) in a way that is detectable via the tamper resistant image hash function. As such, the analytics services may be employed to detect copyright infringement. In addition to image, data, similar methodologies may be employed to detect copyright infringement of audio content. That is, a “perceptual” audio hash function may be employed to detect copyright infringement of audio content. The tool may be a web-based and/or cloud based tool. In at least one embodiment, the tool may be included in an enhanced document editing application, as described herein. The analytics tool may be able to retrieve and verify any copy of the document stored in the document repository, as well as any additional information included in the document stored in the document repository.

The discussions of some of the various embodiments are directed towards providing traceability of an edit history of a digital document that is a digital image. However, it should be understood that the embodiments are not so limited, and the embodiments may also include providing traceability of an edit history of other types or classes of digital documents and assets, such as but not limited to audio/video recordings, records of transactions, and legal documents. Other embodiments may be directed towards providing the traceability of various textual documents (e.g., word processing documents, books, articles, memos, journals, and blogs), spreadsheet documents, slide-deck documents, technical drawing documents, source code for applications, and various works of art and/or entertainment encoded in digital documents.

As used herein, a transition between states of a document may occur whenever the document is saved, copied, moved, “checked in” or “checked out” to a document management system or document repository, updated, or any other such file-oriented operations. Thus, a transition between a first document state and a second document state may be detected when a file encoding the document is saved, re-saved, moved, copied, or the like. In at least some embodiments, a transition in the state of the document may occur when one or more edits, alterations, or updates are provided to the document. As noted above, at least a fingerprint (e.g., a cryptographic hash) of each document state may be recorded into the distributed ledger. Thus, anytime a transition between states of the document is detected, the ledger may be updated. For example, for each save or copy operation performed on a document, the ledger may updated to include the fingerprint of the document's current state. Note that information relating to the contents of the document may be identical in a first and a second state, i.e., the document's contents have not been edited or altered between the first and second states of the document.

As used herein, the term “fingerprint” of a document or the state of the document may refer to a value that is determined and/or generated based on at least a portion of the document's contents. In some, but not necessarily all of the embodiments herein, the value encoded in the fingerprint includes significantly less information than the information encoded in the document's contents. Thus, the fingerprint (or fingerprint value) may be generated based on a fingerprinting algorithm (or fingerprinting function), which maps the document's contents (e.g., a first bit string) onto a fingerprint value (e.g., a second bit string), where the first bit string is significantly longer than the second bit string. In some, but not all embodiments, an inverse function of the fingerprinting function is significantly difficult to determine and/or construct. That is, the only feasible method to determine the first bit string from the second bit string would be a brute force search, employing the fingerprinting algorithm, over the domain of possible first bit strings. Thus, the fingerprinting function may be a cryptographic fingerprinting function. The fingerprinting function may be a non-invertible one-to-one mapping function from the first bit string to the second bit string. However, in other embodiments, the mapping may not be strictly unique or one-to-one. For instance, in some embodiments, the fingerprinting function may exhibit avalanche effects (e.g., significant sensitivities to variations in the first bit string), such that the likelihood of a “collision” between small variations in the document's contents is sufficiently mitigated. Thus, in various embodiments, the function employed to generate a fingerprint may include, or at least be similar to, a cryptographic hash function. However, other embodiments are not so limited and other fingerprinting algorithms, such as but not limited to Rabin's-type fingerprinting algorithm may be employed.

In various embodiments, the fingerprint of a document, may be referred to as the document's “signature.” A fingerprint may also be referred herein as a “message digest,” or simply a “digest” of the message. The document's content (or portions thereof) may serve as the “message.” Thus, as used herein, a “message” may refer to any data encoding information, such as but not limited to the contents of a document. Thus, a fingerprinting function maps the message (e.g., the first data string discussed above) to the message digest (e.g., the second data string discussed above). As such, the fingerprint serves as a digest of the message (e.g., at least a portion of the document's contents). In various embodiments, a fingerprinting function or algorithm is deterministic, infeasible to invert, the message digest is significantly sensitive small variations in the message (i.e., exhibits avalanche effects), and is unlikely to generate the same message digest for separate messages. In at least one embodiment, a fingerprinting function may be the identity function for the contents of the document. That is, a fingerprint of a document may be identical to at least portions of the document.

In some embodiments, the fingerprint of the document may be generated via a tamper resistant image hashing function or algorithm, such as but not limited to a perceptual hashing function, or “p-hash” of the document's contents. A tamper resistant image hashing function, such as a perceptual hash, may include to a hashing algorithm or hash function that is relatively insensitive to certain types of edits or updates to particular features of a document, while being significantly sensitive to other types of edits or alterations to the features of the document. For example, in embodiments where the document is a digital image, a p-hash value of at least a portion of the image (e.g., a portion that includes a visualization of a subject, such as a model) may be generated. In some embodiments, the image may be semantically segmented to identify portions of the image associated with various subjects depicted in the image (e.g., a model and a background). Based on the semantic segmentation of the image, a p-hash algorithm may be employed to generate a p-hash value of the semantically identified portion of the image depicting the model. The p-hash value may be employed as the fingerprint of the image for the current state of the image.

The p-hash algorithm employed to generate the p-hash value of the portion of the image depicting the model may be relatively insensitive to certain classes or types of edits to the model, such as rotations or proportional re-scaling of the size and/or shape of the model. However, the p-hash algorithm may be significantly sensitive to other types of edits to the model, such as non-proportional re-scaling or the enhancement or decrease in the size or shape of portions of the model's figure. That is, the p-hash algorithm may include an avalanche effect for such types or classes of edits to be tracked. In various embodiments, a separate type of hash algorithm may be employed for each of the semantically segmented and/or otherwise identified portions of the image. For example, a first p-hash algorithm may be targeted towards portions of the image that depict human subjects, and a second p-hash algorithm (or any other type of fingerprint generator) may be targeted towards portions of the image that depict non-human subjects. That is, a fingerprint may be separately generated (and included in the distributed ledger) for each semantically segmented portion of the image. In this way, the embodiments may provide traceability for specific types of edits or alterations (e.g., manipulations of the shape of a subject depicted in the image) and for specific subjects depicted with the image, while not tracking other types of alterations and/or particular subjects (e.g., manipulations of the color of the background of the image).

In contrast to blockchain applications that are employed to generate an unalterable record of economic transactions (e.g., Bitcoin implementations), the distributed ledger included herein may include “forks” or bifurcations for various versions or copies of the document. For example, in some embodiments, each time a copy of the document is generated (e.g., generating a second copy of the document from a first copy of the document), a new block (including a fingerprint of the second copy) may be added to the ledger in a branch that bifurcates or forks from the branch tracking the first copy of the document. Thus, edits to the first copy and second copy may be independently tracked via the forking branches of the ledger. Thus, the distributed ledger employed herein may topologically resemble a directed tree graph or tree data structure, where the blocks correspond to the nodes of the tree graph and the reference links between the records correspond to the edges of the graph. Similarly to copying a document, when a new version of the document is generated, a bifurcating branch in the ledger may be generated to track edits to the new version of the document. Providing the image to a different user may also initiate a bifurcating branch in the ledger. Each user of a document may be associated with a separate branch of the ledger. Thus, the edits to multiple copies, versions, and owners of a document may be tracked via the bifurcating branches of the ledger. Because of the tree-like nature of the ledger, various terms such as root node, child nodes, parent nodes, sibling nodes, descent nodes, ancestor nodes, and the like may be applied to the various embodiments.

### Exemplary Embodiment of a Distributed Ledger Network to Facilitate Edit Traceability

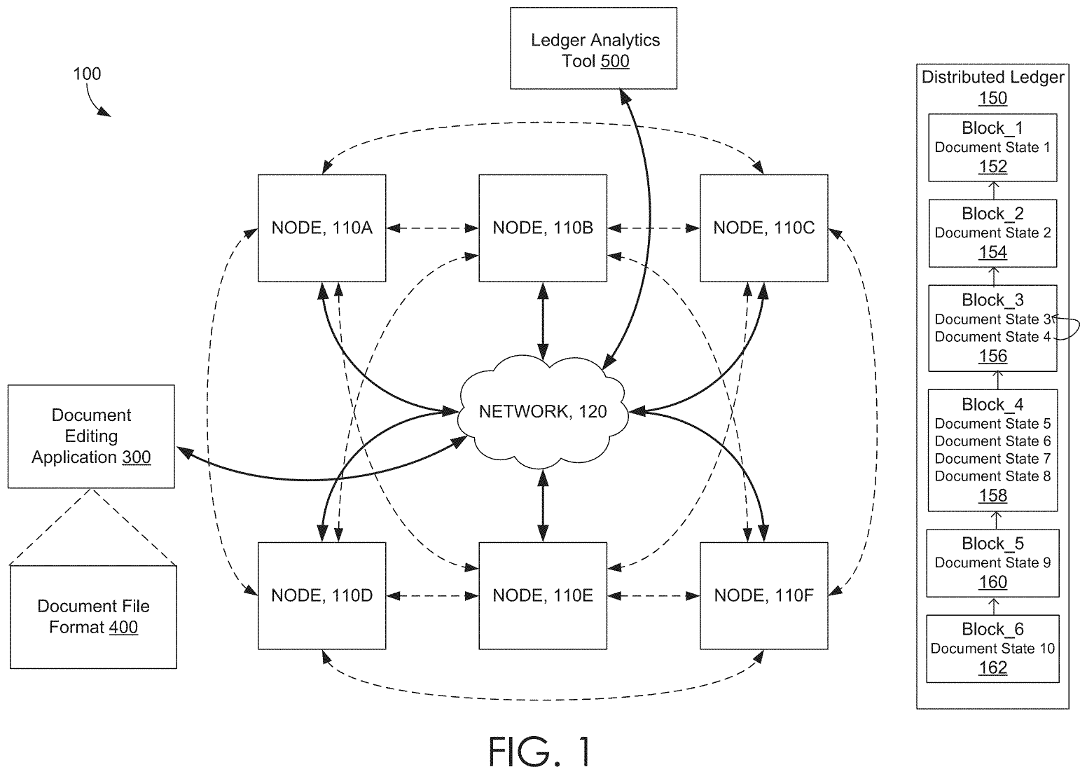

Turning now to FIG. 1, a schematic depiction is provided illustrating an exemplary distributed ledger network 100, which may be employed in the various embodiments to provide traceability for edits and/or alterations to a digital document and/or asset. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

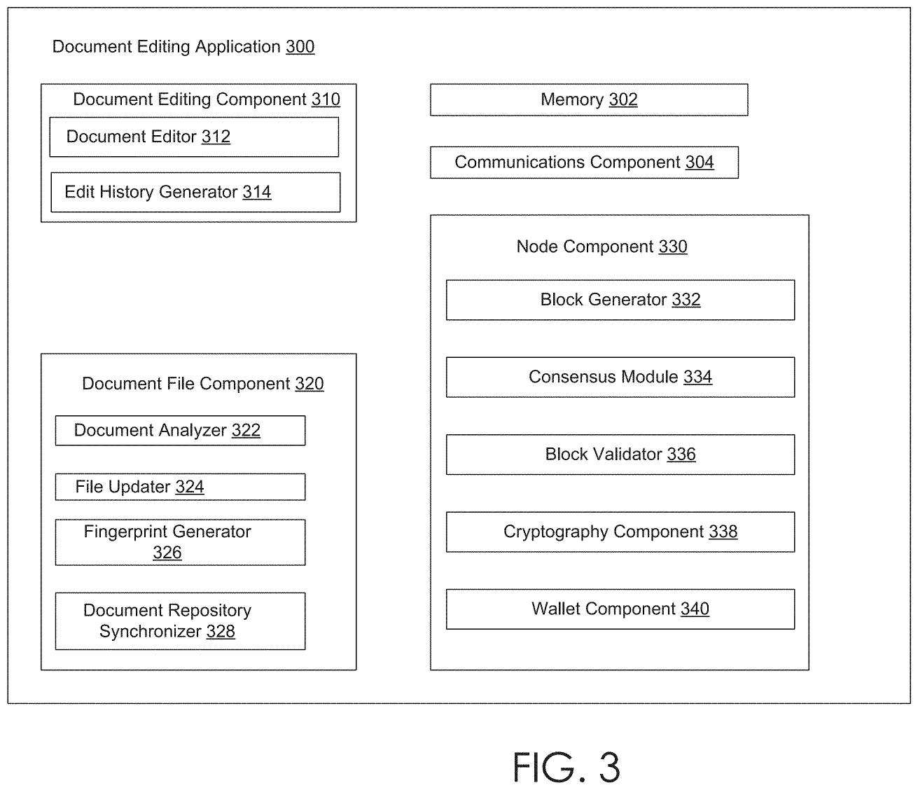

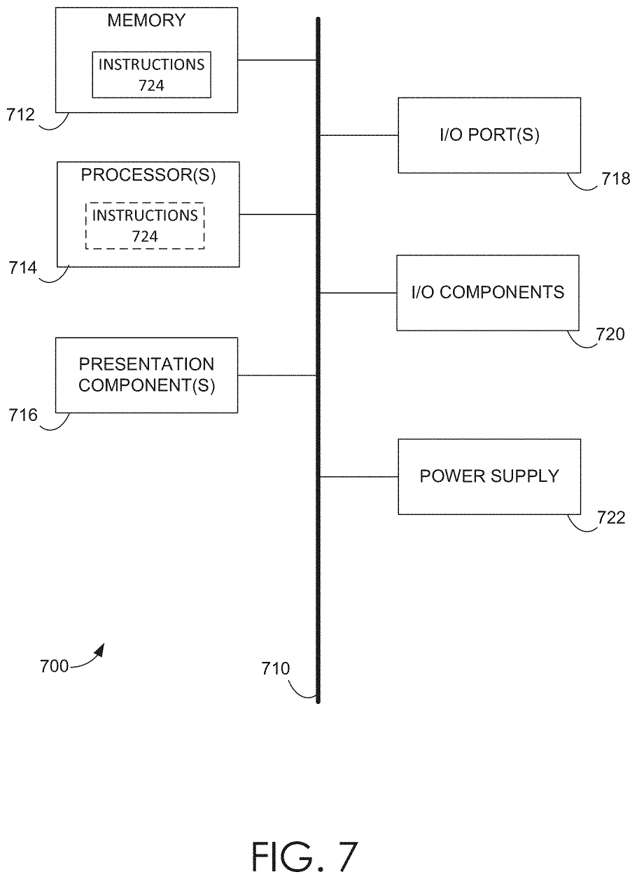

The distributed ledger network 100 depicted in FIG. 1 includes a plurality of nodes 110A-110F that are each in communication with one or more nodes 110A-110F over a network, such as the Internet. In accordance with the present disclosure, each node 110A-110F is a node of a distributed ledger network 100, as later described in accordance with FIG. 3, which is also a computing device later described in accordance with FIG. 7. As noted throughout, various features of the distributed ledger 150 may be equivalent to, or at least similar to the features of a blockchain. Accordingly, throughout, the distributed ledger 150 may be referred to as a blockchain, or a blockchain-like ledger. In some embodiments, and preferably for public blockchain implementations, each node 110A-110F in the distributed ledger network 100 can operate as a peer to every other node 110A-110F of the distributed ledger network 110 such that no single node 110A-110F is more influential or powerful than any other node 110A-110F.

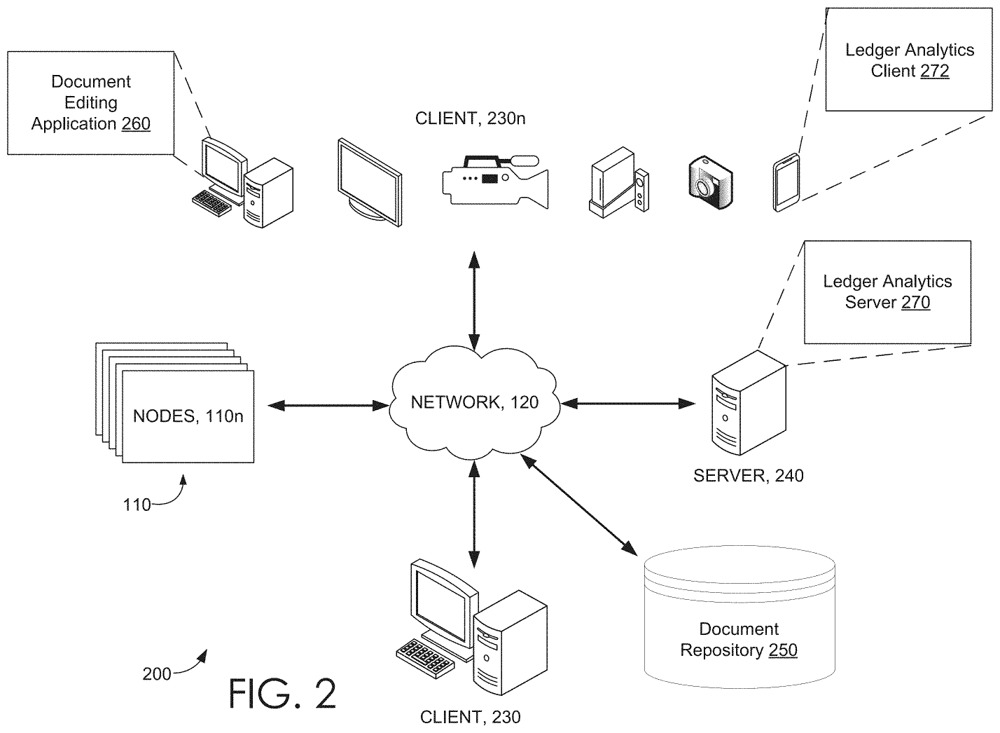

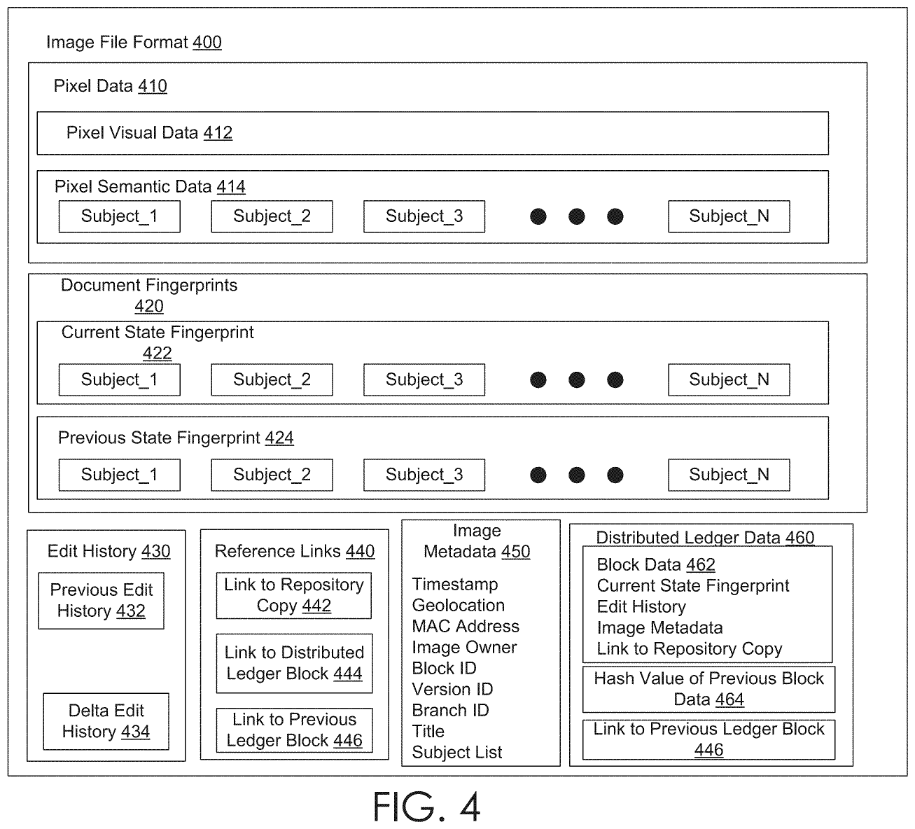

In the various embodiments herein, the blocks of the distributed ledger 150 may encode each state of a document. By encoding the states of a document in distributed ledger 150, traceability of edits and/or alterations to the document may be provided, as well as the various analytics services discussed within. Briefly, each state transition of a document may generate a transaction. The generated transaction may be encoded in a block. As discussed below, the block encoding the transaction may be added to the distributed ledger 150 via a distributed consensus of nodes 110A-110F. A document editing application, such as document editing application 300 may generate a state transition on a document (e.g., a file operation and/or one or more edits on a document). Various embodiments of document editing application 300 are discussed in conjunction with at least FIG. 3. In some embodiments, document editing application may be similar to document editing application 260 of FIG. 2. The document may be stored in an enhanced document file format, such as but not limited to document file format 400. In some embodiments, document editing application 300 may provide one or more of the functionalities of a node, such as but not limited to nodes 110A-110F. Various embodiments of an enhanced document file format are discussed at least in conjunction with FIG. 4.

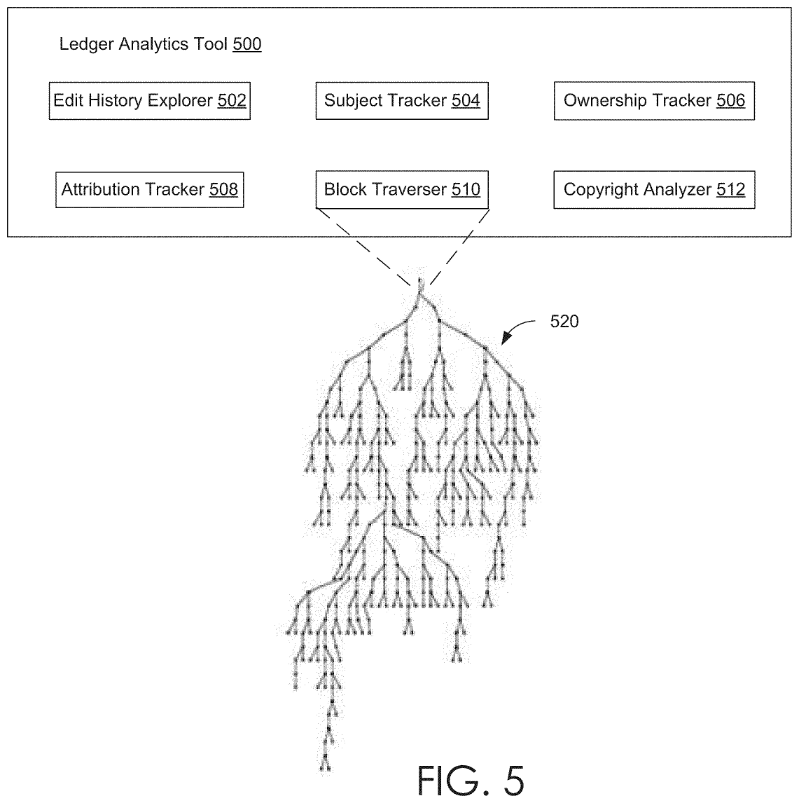

A ledger analytics tool, such as but not limited to ledger analytics tool 500, may provide the various distributed ledger analytics services discussed throughout. Various embodiments of a distributed ledger analytics tool are discussed in conjunction with at least FIG. 5. Ledger analytics tool 500 may be similar to ledger analytics server 240 of FIG. 2. A primary (or master) node of distributed ledger network 100 may provide ledger analytics tool 500.

As shown in FIG. 1, distributed ledger 150 includes six blocks: block_1 152, block_2 154, block_3 156, bloakc_4 158, block_5 160, and block_6 162. Other embodiments of distributed ledgers may include more or less blocks. As discussed throughout, each of the blocks encodes one or more states of the document. Encoding a state of a document may include encoding at least one of a fingerprint of the document's state and/or an edit history of the document associated with the document's state. As a non-limiting example, block_1 152 encodes document state 1, block_2 154 encodes document state 2, and block_3 156 encodes both document state 3 and document state 4. The other blocks are shown to encode additional states of the document. As shown in FIG. 1, each block includes a reference or a link to a previous block. Also shown in block_3 156, an encoding a document's state may include a reference or link to a previous encoding of the document's state (e.g., the encoding of document state 4 includes a reference and/or a link to the encoding of document state 3). The links may be across blocks and/or within the same block.

As used herein, the term “transaction” may refer to any machine-related event that includes at least one of detecting, for a digital document or asset, a transition from a first state (e.g., a previous state) of the document to a second state (e.g., a current state) of the document, generating a fingerprint for the current state of the document, updating any information (such as updating the edit history) included in an enhanced file format for the document, generating one or more blocks that include information associated with the transition of document states, such as but not limited to the document's updated edit history and the document's current state fingerprint, and/or adding such a block to the distributed ledger 150, via a distributed consensus of the block, as well as validating/verifying the contents of any such block that has been added to the ledger.

As noted above, operations performed by nodes can include, among other things, validating transactions, verifying blocks of transactions, and adding records to an immutable database (i.e., the distributed ledger 150) that is collectively maintained by the nodes 110A-110F. It is contemplated, however, that in some embodiments, a particular subset of the nodes 110A-110F can be specifically designated for performing a subset of or all node operations described herein. In this regard, as opposed to embodiments where each node is a peer with other nodes, some embodiments can employ specially-“designated nodes” (preferably for private blockchains or ecosystems where centralization is not a concern) that perform a subset of or all of the described node operations.

In accordance with embodiments described herein, the immutable and/or non-corruptible database collectively maintained by the nodes 110A-110F is referenced herein as a blockchain 150 and/or a distributed ledger 150. The blockchain 150 maintained by the distributed ledger 150 network 100 includes a plurality of records that is immutable by virtue of the distributed nature of the distributed ledger network 100, applied cryptography concepts, and a consensus module (not shown) that is independently included and operated by any number of nodes 110A-110F. While any node can generate a transaction that is encoded in a block (or record) to be added to the blockchain 150, the consensus module requires that the block (or record) be added to the blockchain 150 only based on a determination that a consensus (e.g., greater than 50%) of the nodes 110A-110F (or designated nodes) has collectively validated the transaction. In this regard, while each node 110A-110F can independently store a copy of the blockchain 150, a block or record can only be added to the blockchain 150 when a consensus to add the record has been reached by the nodes 110A-110F (or designated nodes) of the distributed ledger network 100. Due to the decentralized nature of nodes 110A-110F, adding a block or record to the blockchain 150 in this manner may be referred to as adding the block via a decentralized consensus.

In the various embodiments, a transaction may be generated when a document is transitioned from one state to another, such as but not limited to when the document is saved, copied, and/or edited, as well as various other file operations are performed. The generation of such a transaction may include generating a fingerprint of the current state of the document and updating an edit history of the document, as well as updating any other information associated with the current state of the document that is to be tracked. At least the fingerprint and/or the updated edit history may be included in a block (or record) to add to the blockchain 150. To add the corresponding block to the blockchain 150, the corresponding transaction must be verified via a distributed consensus of the nodes 110A-110F. That is, nodes 110A-110F must determine, via a consensus, that the transaction is valid, i.e., at least the document's fingerprint has been correctly generated and the updated edit history accurately reflects the edits to the document. That is, determining the transaction to be valid may include at least one of determining that the updated edit history accurately reflects any edits and/or alterations to the document and/or that the fingerprint of the current state of the document has been generated properly. If a node (or designated node) in the distributed ledger network 100 determines that one or more of the foregoing conditions is not satisfied, the transaction may be determined invalid by the node and the transaction is not passed on (e.g., communicated) to other nodes (or designated nodes) to which it is connected. On the other hand, if the node (or designated node) determines that both of the foregoing conditions are satisfied, the transaction is determined valid and the node passes on (e.g., communicates) the transaction, along with an indication that the node independently validated the transaction, to other nodes 110A-110F (or designated nodes) to which it is connected. As the nodes 110A-110F in the distributed ledger network 100 are all directly or indirectly connected to one another, this validation process continues until the nodes (or designated nodes) collectively determine that a majority (i.e., consensus) has validated the transaction. The collective determination of consensus can be facilitated by virtue of each node (or designated node) maintaining a list of other nodes (or designated nodes) on the network (e.g., by I.P. address or other identifier) along with their respective determinations of transaction validity. This type of verification of the validating of a transaction may be referred to as a distributed consensus. As discussed throughout, upon a distributed consensus of validity of a transaction, a corresponding block may be added to the distributed ledger 150.

As noted throughout, in some embodiments, various incentives may be provided to a user, such that the user provides at least a portion of resources associated with a computing device to enable and/or provide services to implement one or more nodes of noes 110A-110F. Such incentives may be provided by a transaction that includes transfer of ownership of a unit of value, such as but not limited to a digital token, virtual coin, and/or a crypto coin. Asymmetric key cryptography (e.g., private-public key pairs) may be employed to secure and generate a transaction that involves the transfer of such an incentivizing unit of value and/or token.

More particularly, validation of a transaction, which involves the transfer of a unit of value and/or the transfer of ownership of a document, may be facilitated utilizing features of asymmetric key cryptography (i.e., public-private key pairs), among other things. In some aspects, as is commonly known in public blockchains (e.g., Bitcoin), a private key can be employed to generate one or more associated public keys, encrypt data that can only be decrypted by an associated public key, and/or digitally sign data or transactions. On the other hand, a public key can be employed to decrypt data encrypted by an associated private key, encrypt data that only the private key can decrypt, and/or digitally authenticate a digital fingerprint generated by an associated private key. As public keys can be shared freely, public keys generally function as “wallet addresses” that are associated with a private key. In this regard, digital tokens or other units of value (e.g., a virtual coin) can be “transmitted” from one wallet address (i.e., a public key of a sender) to another wallet address (i.e., a public key of a receiver). In actuality, however, the transmission of a digital token or unit of virtual value is not a physical transfer, but is represented as a record of transfer from one wallet address to another that, if validated, is recorded onto the blockchain 150. The record is not finalized (i.e., added to the blockchain 150), however, until the transfer is validated by a distributed consensus of the nodes 110A-110F in the distributed ledger network 100, as described above.

To generate a transaction to transfer a digital token(s), ownership of a digital asset, or other such transaction, the owner of the sending wallet address must digitally sign the transaction with the private key associated with the sending wallet address. Nodes 110A-110F (or designated nodes) of the distributed ledger network 100 must independently determine that the transaction from the sending wallet address is valid by digitally authenticating the digital fingerprint with the sending wallet address (i.e., the public key). The nodes 110A-110F (or designated nodes) must also independently determine, by referencing their independently-stored copy of the blockchain 150, that the sending wallet address is in fact associated with the digital token being transferred, or that the sending wallet address has sufficient liquidity (i.e., has a calculated aggregate value based on associated records in a local copy of the blockchain 150) to transfer the unit(s) of value. If a node (or designated node) in the distributed ledger network 100 determines that either of the foregoing conditions is not satisfied, the transaction is determined invalid by the node and the transaction is not passed on (e.g., communicated) to other nodes (or designated nodes) to which it is connected. On the other hand, if the node (or designated node) determines that both of the foregoing conditions are satisfied, the transaction is determined valid and the node passes on (e.g., communicates) the transaction, along with an indication that the node independently validated the transaction, to other nodes 110A-110F (or designated nodes) to which it is connected. As the nodes 110A-110F in the distributed ledger network 100 are all directly or indirectly connected to one another, this validation process continues until the nodes (or designated nodes) collectively determine that a majority (i.e., consensus) has validated the transaction. The collective determination of consensus can be facilitated by virtue of each node (or designated node) maintaining a list of other nodes (or designated nodes) on the network (e.g., by I.P. address or other identifier) along with their respective determinations of transaction validity. It should be understood that such asymmetric key cryptography mechanisms may be employed in the various embodiments to transfer other digital assets, such as but not limited to the ownership of a document, read/write/access permissions of the document, and the like. It should also be understood that such asymmetric key cryptography mechanisms may be employed to validate other sorts of transactions included in the various embodiments, such as but not limited to detecting a transition from a previous state of a document to a current state of the document, generating a fingerprint for the current state of the document, updating any information (such as updating the edit history) included in a file format for the document, generating one or more blocks that include information associated with the transition of document states, such as but not limited to the document's updated edit history and the document's current state fingerprint, and/or adding such a block to the distributed ledger 150.

After a consensus of validity for a transaction has been reached by the nodes 110A-110F (or designated nodes), the transaction awaits confirmation (i.e., addition to the blockchain 150). As the nodes 110A-110F (or designated nodes) can be peers with each other, any node (or designated node) can participate in the process of adding the transaction to the blockchain 150. For purposes of background, the blockchain 150 includes records of validated transactions that are grouped into a cryptographically chained series of blocks, whereby each block includes a subset of these records. Any node 110A-110F (or designated node) can perform the process of block generation, which can be implemented in a variety of ways based on a consensus algorithm implemented within its consensus module including, but not limited to, proof of work, proof of stake, proof of authority, practical Byzantine Fault Tolerance, or Federated Byzantine Agreements. As the aforementioned processes for block generation are generally known in the art, additional detail for these processes are not described herein. It is contemplated, however, that any implementation of block generation and consensus determination can be employed in accordance with the present disclosure. More importantly, as the general outcome of block generation is relatively similar among these implementations, the following description is provided irrespective of the block generation aspect of the consensus module.

To add a validated transaction to the blockchain 150, the transaction must first be included into a block that is being generated by one of the nodes 110A-110F (or designated nodes) and subsequently validated by a consensus of the nodes (or designated nodes) in the distributed ledger network 100. The transaction can be independently included into a block, or grouped together with other transactions, either of which are included within the purview of the present disclosure. Such implementations may vary, however, based on consensus module design and/or a block size (i.e., memory limitation) implemented or defined within in the consensus module operated by the nodes 110A-110F (or designated nodes). The node generating the block must also include, into the block it is generating, a fingerprint (e.g., a cryptographic hash) of the block most-recently added to the blockchain 150. Once generated in accordance with consensus rules defined within the consensus module, the node generating the block can send the generated block to the nodes (or designated nodes) to which it is connected.

The nodes (or designated nodes) receiving the generated block can then verify that the block includes one or more valid transactions, includes a proper fingerprint (e.g., a hash value) of the block most-recently added to the blockchain 150, and was generated in accordance with the defined consensus rules. Upon verifying the foregoing, the nodes (or designated nodes) can pass on (e.g., communicate) the verified block to its neighboring nodes (or neighboring designated nodes). In this way, similar to how a transaction is validated by a determined consensus of the distributed ledger network 100, the generated block including at least the transaction can be verified by another determined consensus of the nodes (or designated nodes). When a determination is made by a consensus of the nodes 110A-110F (or designated nodes) that a block is verified, the newly-verified block is added to the blockchain 150 immediately subsequent to the previously-added block, the fingerprint of the previously-added block being included in the newly-verified block. As such, each block is cryptographically “chained” to a previous block and a subsequent block. In other words, the cryptographic fingerprints or hashes of the previous blocks, facilitate maintenance of the order and accuracy of records included in the blockchain 150.

In some instances, if the same transaction is included into a block generated by different nodes (or designated nodes) and validated throughout the network within a substantially similar timeframe, the blocks can be temporarily confirmed leading up to a fork in the blockchain 150 (e.g., two potential branches stemming from the main chain). The forked chain can be maintained by the nodes (or designated nodes) until a determination is made, by a consensus of the distributed ledger network 100, that one of the forks has a larger quantity of blocks than the other. Based on a subsequent determination that one of the forks is shorter than the other, the nodes (or designated nodes) can prune (e.g., delete) the shorter chain, and maintain the longer chain as the determinative blockchain 150.

As discussed throughout, the blockchain 150 (and/or distributed ledger 150) may store blocks and/or records that include at least a fingerprint (e.g., a cryptographic hash) for each state of the document. The fingerprint may be sensitive to, and thus indicative of, any edits and/or alterations to the document. For example, a hashing algorithm that is prone to avalanche effects may be employed to generate the fingerprint. In some embodiments, an algorithm, such as but not limited to a p-hash algorithm, may be employed, where the avalanche effects of the algorithm is not sensitive to certain types and/or classes of edits, but avalanches when other types of edits are applied to the document. The blockchain 150 may store any of the information included in the various embodiments of the enhanced document file format discussed herein, including but not limited to the edit history of the document.

The blockchain 150 may also store blocks or records relating to transfers of digital tokens or monetary value. In this regard, a record can include any type of electronic record, including but not limited to one or more transactions, smart contracts, electronic documents, images or other digital media, URIs, alphanumeric text, unique identifiers, I.P. addresses, timestamps, hashes of any of the foregoing, or references to any of the foregoing. Any of the foregoing examples can be viewed as being the subject of a transaction, or can be indirectly associated with a transaction. For instance, ownership of an asset stored in a medium other than the blockchain 150 (e.g., a remote storage device, a cloud server, a database) can be referenced with a unique identifier. If the asset is a digital asset, a URI and/or hash of the digital asset can be the subject of the transaction. If the asset is a tangible asset, a unique identifier associated with the tangible asset can be the subject of the transaction. It is contemplated that any combination or alternative to the foregoing examples remain within the purview of the present disclosure.

### Exemplary Embodiment of a Document Provenance System

Referring now to FIG. 2, a schematic depiction is provided illustrating an exemplary document provenance system 200 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 200 can include, among other things, a distributed ledger network 100 comprising a plurality of nodes 110n as described with reference to FIG. 1, each in direct or indirect communication with one another via a network 120. It is contemplated that the nodes 110n can include a subset of designated nodes authorized to perform specifically-designated operations, such as validation, verification, or block generation, among other things. The system can also include one or more client devices, such as client 230, 230n. It is contemplated that any one or more nodes 110n can be a client 230, 230n, and one or more clients, 230, 230n can be a node in accordance with embodiments described herein. In this regard, nodes 110n and clients 230, 230n are computing devices also described herein in accordance with FIG. 7.

In one aspect, a client 230, 230n and can include the consensus module similarly included in other nodes 110n (or designated nodes) within the distributed ledger network 100. In another aspect, the client 230, 230n can generate transactions that can initially be validated locally, via the consensus module included therein, before the transaction is passed on to other nodes. In another aspect, a client 230, 230n can be in communication with one or more nodes 110n via the network 120, and can locally generate a transaction for communication via the network 120 to one or more nodes 110n that the client 230, 230n is in communication with. In this way, the one or more nodes 110n (or designated nodes) receiving the transaction directly or indirectly from the client 230, 230n can validate the transaction in accordance with the present disclosure.

In various embodiments, at least one of clients 220, 230n may run, execute, and/or otherwise implement an enhanced document editing application, such as but not limited to document editing application 260. Various embodiments of document editing application 260 are discussed at least in conjunction with FIG. 3. However, briefly here, in addition to enable a user to edit a document, such as but not limited to a digital image, enhanced document editing application 260 is enabled to generate information and include the information in a document file that is encoded in an enhanced document file format. Various embodiments of the enhanced document file format are discussed in conjunction with FIG. 4. The enhanced document editing application 260 may be enabled to operate as at least one node of nodes 110, 100n. Document editing application may store at least portions of the ledger, generate blocks to add to the ledger, partake in a distributed consensus operation required when adding blocks to the distributed ledger, verify/validate the content of the blocks of the ledger, and the like. A node component of an enhanced document editing application 260, may serve as at least a node of nodes 110, 110.

In some aspects, any node 110n can operate as a node that includes the consensus module, and any client 230, 230n can operate as a client device that can: transmit communications to one or more nodes 110n, generate transactions, and receive communications (e.g., transaction status, blockchain data) from one or more nodes 110n. For purposes of simplicity, the following description will reference a client 230, 230n as a node 110n, though embodiments are not limited as such.

In some embodiments, the system 200 can further include a server device, such as server 240. The server 240 can be in communication with one or more nodes 110n to send generated transactions to the one or more nodes 110n, request and receive transaction status information from the one or more nodes 110n, and/or request and receive blockchain data from the one or more nodes 110n, among other things. In some further embodiments, server 240 can include can include one or more computing devices, also described in accordance with FIG. 7, whereby the one or more computing devices include a consensus module to operate as a node 110n (or designated node). Among other things, the server 240 can further provide one or more services, such as data storage services, web hosting services for one or more websites, user authentication services, certificate authentication services, backup services, data mining services, “cloud”-stored data or web search services, block explorer services, analytics services, and the like, including any combination thereof.

To provide the block explorer and analytic services, server 240 may run, execute, and/or otherwise implement an enhanced ledger analytics tool, such as but not limited to ledger analytics server 270. To receive the various services provided any ledger analytics server 270, any of clients 230, 230 may run, execute, and/or otherwise implement a corresponding ledger analytics client 272. Ledger analytics server 270 may provide its various services as software as service (SAS). For example, ledger analytics server 270 may provide its services as “cloud-based” services, “web-based” services, and/or a combination thereof. Various embodiments of an enhanced ledger analytics tool are discussed in conjunction with at least FIG. 5. However, briefly here, an enhanced ledger analytics tool may provide analytics-oriented services, such as but not limited to traversing the ledger, verifying/validating the integrity of the contents of ledger, and/or retrieving, recalling, and providing any information included in the blocks of the ledger, including but not limited to the edit history of a document. As such, the ledger analytics server 270 may be able to retrieve and/or recall any state of the document throughout the document's history or lifetime. The enhanced analytics tool may provide a complete edit history (or provenance chain) for a document, as well as each state of the document. For example, in embodiments directed towards an image, via a p-hash algorithm, a composite image may be analyzed so that subjects included therein are identified and extracted so that a corresponding p-hash is generated for each. Employing the enhanced tool, via traversing the ledger, the p-hash value of a particular subject could be searched to identify, among other things, an original image state and each subsequent image state.

System 200 may additional include a document repository 250. Any of document editing application 260 or ledger analytics server 270 may be enabled to store, retrieved, and/or recall documents in the document repository 250. In various embodiments, for each state of a document, a copy of the document may be stored in the document repository 250. In each block added to the ledger, a reference link to the corresponding copy of the document in the document repository may be included. Thus, each state of the document may be recalled and/or retrieved via the reference link (to the repository copy of the document) included in the corresponding block. To verify the integrity of the repository copy of the document, a state fingerprint of the retrieved copy of the repository copy may be generated (via the same avalanche effect-prone algorithm that initially generated the state's fingerprint) and compared to the state fingerprint stored in the corresponding block. Thus, the integrity of copies for each state of the document stored in the document repository 250 are reliable, immutable, and non-corruptible. The document repository 250 may be a cloud-based document repository. The document repository may be a document managing system, where documents may be “checked in” and “checked out” by users based on user permissions

### Exemplary Embodiments of a Document Editing Application and a Document File Format

FIG. 3 provides a block diagram 300 that depicts an exemplary document editing application 300. Document editing application 300 may be an enhanced document editing application, and may be at least similar to document editing application 260 of FIG. 3. Document editing application 300 may be enabled to generate, read, write, edit, alter, save, and other operations involving an enhanced document file format, such as but not limited to image file format 400 of FIG. 4.

Document editing application 300 may include one or more of memory 302, communications component 304, document editing component 312, document file component 320, and node component 330. The memory 302 can include any type of transitory or non-transitory memory, such as a hardware storage device, random access memory (RAM), a cache, read-only memory (ROM), and the like, including any combination thereof. The memory 302 can be employed to store executable computer code that, when executed by one or more processors of the client devices 230, 230n of FIG. 2, perform operations defined and/or implemented within the document editing application 300 described herein. The memory 302 can also be employed to store data communicated from other nodes 110n, clients 230, 230n and/or servers 240, such as those described in accordance with FIG. 2. The communicated data stored in memory can include, among other things, digital documents, transactions involving digital documents, one or more blocks of a blockchain, determinations of validity, determinations of authentication/verification, unique identifiers and/or IP addresses of one or more nodes 110n, and other types of electronic data not limited to the foregoing.

The communications component 304 can include any type of communications device that enables the node 110n to communicate with other nodes 110n, clients 230, 230n and/or servers 240, such as those described in accordance with FIG. 2. Communications can be facilitated utilizing wired or wireless communications, and can employ any short or long-range communications technology including, but not limited to, LANs, WANs, Ethernet, the Internet, WiFi, Bluetooth, NFC, optics (e.g., QR codes, Infrared), Zigbee, radio, RFIDs, and the like.

Document editing application 300 may further include a document editing component, document file component 320, and a node component 330. Document editing component is generally responsible for enabling the editing of the contents of a document, such as but not limited an image stored via image file format 400, and generating an edit history for the document based on the edits and/or alterations of the document's contents. Document file component 320 is generally responsible for analyzing a document (e.g., semantically segmenting an image based on the various subjects depicted in the image), detecting a transition from a previous state to a current state, in response to detecting the transitions of states of the document, generating a fingerprint of the current state, and storing and/or retrieving documents stored in a document repository, such as but not limited to document repository 250 of FIG. 2. Node component 330 is generally responsible for enabling all the operations and functionalities of nodes 100, 110n of FIGS. 1-2.

In some embodiments, document editing application 300 may not include node component 330, or may include only a sub-portion of the modules, components, and/or functionalities of node component. In these embodiments, at least some of the capabilities, functionalities, responsibilities, and/or operations of the node component 330 may be offloaded to nodes of the ledger, such as but not limited to any of one or more nodes 110, 110n of FIGS. 1-2. In at least one embodiment, document editing application 300 may include cryptography component 338 and wallet component 340, while not including the other components or modules of node component 330. In such an embodiment, the various functionalities, responsibilities, and/or operations of the cryptography component 228 and the wallet component 330 may be carried out via document editing application 300, while other node operations are performed via other nodes of the distributed ledger. For example, document editing application 300 may generate a transaction (e.g., detect a state transition of a document). Document editing application 300 may package and send the transition to nodes, such that the transaction may be added to the ledger.

As noted throughout, in some embodiments, multiple transactions (e.g., multiple state changes of a document detected via one or more instances of document editing application 300) may be packaged into a single block to be added to the ledger. In such embodiments, each instance of a plurality of instances of document editing application 300 sends one or more transactions to at least one node of the ledger. The multiple transaction may be packed into one or more blocks. The one or more blocks may be added to the ledger via a distributed consensus performed via the ledger network.

In at least one such embodiment, document editing application 300 detects a state change of the document and generates a transaction corresponding to the state change. The transaction (or at least data indicating the transaction) may be sent to a node of the ledger. The node that receives the transaction (or transaction data) may provide the transaction to one or more other nodes. As discussed throughout, the nodes may be arranged in a peer-to-peer distributed network. The transaction may be received by at least a consensus of the nodes via the peer-to-peer network. The nodes may verify the transaction and generated a distributed consensus of the transaction and add the transaction to the ledger. In some embodiments, document editing application 300 may package the transaction (or transaction data) into a block. In other embodiments, a node of the ledger network may package the transaction into a block.

Various embodiments of document editing application will be described in the context of FIG. 4. FIG. 4 provides a block diagram 400 depicting an exemplary image file format 400. Image file format 400 may be an enhanced file format for storing and/or encoding image represented via image data, i.e., pixel data. Although image file format is directed towards storing an image, it should be understood how other enhanced document file formats, for other types of documents, may be similarly arranged. Generally, image file format may include structured and/or non-structured data, such as the document's content (i.e., pixel data 410), document fingerprints 420, the document's edit history 430, various reference links 440, image metadata 450, and distributed ledger data 460.

Pixel data 400 may encode the contents of an image. The image may include multiple subjects. In one embodiment, there may be N subjects (e.g., various individuals, various objects, foreground, background, and the like) depicted in the image, where N is a positive integer. The N subjects may be semantically labeled as subject_1, subject_2, subject_3, . . . , subject_N. The N subjects may be visually depicted via pixel values included in pixel visual data 412. The pixel visual data 412 includes pixel data that encodes visual features of the depicted subjects. In one non-limiting embodiment, the pixel values included in visual pixel data 412 may be encoded via RGB values.

The multiple subjects may be segmented via various methods. In at least some embodiments, document editing application 300 may be an image editing application and document editor 310 may include one or more tools and/or operations that enables a user to manually identify regions in an image that depicts various subjects. For example, a user may employ an “outlining” tool to manual outline one or more regions included in the image that depict one or more subjects. The outlines may be employed to generate one or more masks, to mask off the identified regions and/or subjects. In at least some embodiments, the segmenting of an image may be at least partially automated. For example, document editing component 310 may include a “magic wand” tool that enables a user to select a subject depicted in the image. Via various machine vision and/or other machine learning methods, the regions of the image that depicts the selected subjects may be automatically identified and masks for the identified regions may be automatically generated to determine the pixels associated with the depicted subjects. In at least one embodiment, the subjects and regions may be automatically identified via machine and/or computer vision. For example, as discussed below, a neural network, such as but not limited to a convolutional neural network (CNN) and/or an recurrent neural network (RNN) may be employed to automatically identify depicted subjects (e.g., object and/or facial recognition), and semantically segment the image into one or more regions depicting the automatically identified and/or detected subjects. Document analyzer 322 may include machine and/or computer vision capabilities that enable the at least partially automated identifying subjects and segmenting the image into one or more regions depicting the subjects.

As discussed throughout, the image may be semantically segmented, such that at least a portion of the pixels encoding the image may be labeled via a semantic label associated with the various depicted subjects. Pixel semantic data 414 may include the semantic labels for the pixels. That is, as shown in FIG. 4, via pixel semantic data 414, each pixel that is depicting subject_1 may grouped. Similarly, the pixels depicting the other subjects may be grouped via pixel semantic data 414.

Image file format 400 may include one or more document fingerprints 420. In some embodiments, image file format 440 may include a fingerprint for the image's current state, i.e., current state fingerprint 422. Image file format 440 may include the fingerprint of the image state, i.e., previous state fingerprint 424. In various embodiments, when a transition from a first state to a second state is detected and/or observed, the fingerprint encoded in current state fingerprint 422 is written into previous state fingerprint 424. The fingerprint of the current state is generated and written into current state fingerprint 422. In various embodiments, a fingerprint of the current state of the document may be generated by performing one or more cryptographic hash algorithms and/or cryptographic hash functions on at least a portion of the pixel data 412. In at least one embodiment, the fingerprint of document may be the un-hashed pixel visual data.

In some embodiments, the fingerprint of the document may be generated via a tamper resistant image hash function, such as but not limited to a perceptual hash, or “p-hash” of the document's contents. A tamper resistant image hash function, such as a perceptual hash, may include a hashing algorithm or hash function that is relatively insensitive to certain types of edits or updates to particular features of a document, while being significantly sensitive to other types of edits or alterations to the features of the document. For example, in embodiments where the document is a digital image, a p-hash value of at least a portion of the image (e.g., a portion that includes a visualization of a subject, such as a model) may be generated. In some embodiments, the image may be semantically segmented to identify portions of the image associated with various subjects depicted in the image (e.g., a model and a background). Based on the semantic segmentation of the image, a p-hash algorithm may be employed to generate a p-hash value of the semantically identified portion of the image depicting the model. The p-hash value may be employed as the fingerprint of the image for the current state of the image.

The p-hash algorithm employed to generate the p-hash value of the portion of the image depicting the model may be relatively insensitive to certain classes or types of edits to the model, such as rotations or proportional re-scaling of the size and/or shape of the model. However, the p-hash algorithm may be significantly sensitive to other types of edits to the model, such as non-proportional re-scaling or the enhancement or decrease in the size or shape of portions of the model's figure. That is, the p-hash algorithm may include an avalanche effect for such types or classes of edits to be tracked. In various embodiments, a separate type of hash algorithm may be employed for each of the semantically segmented and/or otherwise identified portions of the image. For example, a first p-hash algorithm may be targeted towards portions of the image that depict human subjects, and a second p-hash algorithm (or any other type of fingerprint generator) may be targeted towards portions of the image that depict non-human subjects. That is, a fingerprint may be separately generated (and included in the distributed ledger) for each semantically segmented portion of the image. In this way, the embodiments may provide traceability for specific types of edits or alterations (e.g., manipulations of the shape of a subject depicted in the image) and for specific subjects depicted with the image, while not tracking other types of alterations and/or particular subjects (e.g., manipulations of the color of the background of the image). Both current state fingerprint 422 and previous state fingerprint 424 include p-hash values for each of the N depicted subjects.

Image file format 400 may also include an edit history 430 for the document. For example, for each edit applied to the contents of the document, the edit history may be updated to encode information regarding the edit. Edit history 430 may include an encoding of a list of specific edits to the document, e.g., a listing of specific edit operations performed on the image. For each edit in the edit history 430, the edit history 430 may indicate a specific user associated with edit, i.e., the edit history 430 may include a user attribution for each of the edits and/or alterations recorded and/or documented in the edit history. The user attributions may be tracked in composite works. In at least one embodiment, the edit history 430 may include at least a delta edit history 434. In some embodiments, the edit history includes both the delta edit history 434 and a previous edit history. The previous edit history 432 includes all the edits up until the previous state transition of the image. The delta edit history 434 may include all the edits to the image that occurred between the most previous state transition and the current state transition of the image.

Image file format 400 may also include various reference links 440. As used herein, a “reference link,” a “reference,” or simply a “link” may include any reference to a location of a resource, such as but not limited to a document, a document encoded in image file format 400, a record and/or a block in the ledger, or such. The reference may include an address, a pointer, a link, or any other such indication of a location of data within a system. Reference links 440 may include a link to a repository copy 442 of the image. As discussed throughout, a copy of a document may be stored in a document repository, such as but not limited to document repository 250 of FIG. 2. When the copy of the image is stored to the image repository, image file format 400 may be updated to include the link to the repository copy 442. In various embodiments, only the contents (i.e., pixel visual data 412) may be stored in the repository. In other embodiments, a larger portion of image file format is stored in the repository. In some embodiments, the entirety of the data encoded in image file format 400 may be stored in the image repository. In addition to the link to repository copy 442, some embodiments may also include a link to the repository copy of the image's previous state. It should be understood that in embodiments where only the delta edit history 434 is included in edit history 430, the entire edit history 430 may be reconstructed via following the links to the repository copy of the images previous state and concatenating and/or combining all of the delta edit histories of the previous states. Reference links 440 may include a link to the distributed ledger block 444 that corresponds to the current state of the image. Reference links 440 may include a link to the previous ledger block 446.

Image file format 400 may include various image metadata 540. Image metadata 450 may include virtually any information pertaining to the image, such as but not limited to a image capture timestamp, geolocation, a MAC address (or other identifier) of a camera device employed to capture the image, a user of the camera device and owner of the image, and the like. Metadata 450 may additionally include any other data, such as but not limited to a block ID of the corresponding block within the ledger, a document version ID, a branch ID that identifies the corresponding branch in the distributed ledger, a title of the image, a list of the N subjects depicted in the image, and the like. Virtually any information may be included in image metadata 450.

Image file format 400 includes distributed ledger data 460. As noted throughout, upon the transition to a new state of the image, information pertaining to the image is written into a block (or record) and the block is added to the distributed ledger. The data to write to the block is included in the distributed ledger data 460. In order to avoid inefficiencies of replicating data, block data 462 may include reference links to the corresponding data within image file format 400. Block data 462 may include virtually any of the data included in image file format 400, including but not limited to current state fingerprint 422, edit history 430, at least portions of image metadata 450, the link to the repository copy 442 of the image, and any other such information. In some embodiments, the delta edit history 434 is included in block data 462. As noted throughout, the entirety of the edit history 430 may be reconstructed via combing the delta edit histories for all the previous states. As indicated throughout, and consistent with blockchain-like distributed ledgers, the block corresponding to the current state of the image also includes a hash value of at least a portion of the previous block data 464. That is, hash value of previous block data 464 may include a hash value of at least a portion of the information included in block data 462 for the previous state of the image. As also consistent with blockchain-like distributed ledgers, the distributed ledger data 460 includes the link to the previous ledger block. When adding a new block to the distributed ledger, as least block data 462, hash value of previous block data 464, and link to previous ledger block 446 may be written to the block.

As indicated throughout, in some embodiments, a block in the ledger may include multiple transactions. A single block in the ledger may include the data (distributed ledger data 460) associated with multiple state changes of the document. That is, a single block may include a first instance of distributed ledger data 460 associated with a first state transition of the document, and a second a second instance of distributed ledger data 460 associated with a second state transition of the document. For example, multiple state transitions of a document (e.g., multiple edits and/or file operations) may occur within the period of time it takes to generate a distributed consensus and add a block to the ledger. In some embodiments, transactions (as documented via distributed ledger data 460) may include timestamps that indicate the date and time of the state transitions. The timestamps may be included in distributed ledger data 460. The multiple transactions (and links between the multiple transactions) may be temporally ordered within a single block, via the included timestamps.

Turning our attention back to FIG. 3, and in non-limiting embodiments, document editing application 300 may be an enhanced image editing application that is enabled to generate, read, write, edit, alter, save, and other operations involving image file format 400. The pixel visual data 412 of image file format 400 may be generated via a camera device.

Document editing component 310 may include a document editor 312 and an edit history generator 314. Document editor 312 is generally responsible for enabling the edits and/or alterations to the contents of a document. For example, document editor 312 generally enables a user to apply various edits and/or alterations to the pixel visual data 412. A user may retouch a subject depicted in an image via removing various blemishes in the subject. Document editor 312 may enable a user may re-shape and/or re-size various features of a subject. In various embodiments, document editor 312 may enable various “deepfake” deep-learning methods to provide image editing capabilities. Based on the operation of document editor 312, and in some embodiments, a user employing document editor 312, edit history generator 314 generates edit history 430.

Document file component 320 is generally responsible for interacting with image file format 400. Document file component 320 may include a document analyzer 322, a file updater 324, a fingerprint generator 326, and a document repository synchronizer 328. Document analyzer 322 may be an image analyzer and include various machine and/or computer vision capabilities. At least some of the computer vision capabilities may be employed via artificial intelligence (AI) technologies, including machine learning. Some of the machine learning may include deep learned methods. For example, document analyzer 322 may be implemented, at least partially, via neural networks, such as but not limited to encoder/decoder convolutional neural networks (CNNs), long short-term memory (LSTM) neural networks, and the like. In at least one embodiments, document analyzer 322 employs various object-recognition methods to determine N subjects depicted in the image, and semantically segments the image into regions corresponding to the subjects. Thus, document analyzer 322 may generate pixel semantic data 414 from the pixel visual data 412.

File updater 324 is generally responsible for detecting a transition of states of the image (e.g., an edit operation, a file operation, or the like). Upon detection of such a state transition, filer updater 324 updates any of the data included in image file format 400 that is impacted via the state transitions, such as but not limited to pixel data 410, document fingerprints 420, edit history 430, reference links 440, image metadata 450, and distributed ledger data 460. Fingerprint generator 326 generates the signal of the current state of the image. In various embodiments, fingerprint generator 326 may employ a cryptographic hash function on at least a portion of the pixel data 414. In some embodiments, fingerprint generator 326 may employ a p-hash function on the various regions of pixel values depicting the various subjects. Fingerprint generator 326 may employ pixel semantic data 414 to determine which portions of the image to apply the various p-hash functions on. Document repository synchronizer 328 is generally responsible for saving, recalling, and/or retrieving copies of new states of the image to an image repository, such as but not limited to document repository 250 of FIG. 2. Document repository synchronizer 328 may save each iteration of image file format 400 to the image repository.

Node component 330 of document editing application 300, may provide at least one of nodes 110, 110n for the distributed ledger. The node component 330 may run as a background process on whichever computing device is running document editing application 330. In other embodiments, the node component 330 may run only run when the document editing application 300 is currently being employed via the user. Various incentives (e.g., a digital token) may be provided to the user, such that the user enables their machine resources to be employed as a node and allow the node component to access their machine's resources to perform activities related to the maintenance of the ledger, such as but not limited to storing at least portions of the ledger, generating blocks for the ledger, verifying/validating the contents of the blocks, and participating in the distributed consensus operations required to add block to the ledger.

The node component 330 can include any number of components or subcomponents that, together with the memory 302 and communications component 304, enable the node 110n to operate as a peer node (or a peer to other “designated” nodes) in a distributed ledger network, such as distributed ledger network 100 described in accordance with FIG. 1. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Node component 330 may include one or more of a block generator 332, consensus module 334, block validator 336, cryptography component 338, and wallet component 340. The block generator 332 is generally responsible for generator one or more blocks to the added to the ledger. Block generator 332 may generate a block based on the information included in the distributed ledger data 460 of image file format 400. Block generator may generate a block of information to be added to the distributed ledger when a transition in the image's state is detected.

Consensus module 334 is generally responsible for enabling a node to participate in the distributed consensus methods for adding a block, generated via block generator 332, to the distributed ledger. In at least one embodiment, consensus module 334 analyzes the information included in distributed ledger data 460, as well as other portions if image file format 400, to determine whether the information to be added to the ledger is accurate. For example, consensus module 334 may determine whether the current state fingerprint is reflective of the document's current state, whether the edit history accurately indicates the edits made to the document, and whether a user that initiated the state transition is authorized to have data added to the distributed ledger. Consensus module 334 may determine whether the transaction that initiated the state transaction is a valid transaction. As discussed throughout, prior to a block being added to the ledger, a consensus of nodes storing the ledger must agree that the transaction is a valid transaction. For transactions involving the transfer of ownership of a digital asset, such as ownership of the document or a digital token, consensus module 334 may determine the whether the parties have control of the digital asset, whether they have the resources to cover the transaction, and/or whether they have user permissions granting them the ability to transfer and/or receive the digital asset.

Block validator component 336 is generally responsible validating the information in the blocks of the ledger. For example, the integrity of the ledger may be periodically checked, at least partially, by block validator 336. Using the hash value of the previous block 464 and the link to previous block 446, block validator component 336 may validate and/or verify that the contents of the previous block have not been tampered with and/or edited. Wallet component 340 may manage the transferring and receiving of digital tokens employed in the various embodiments.

Cryptography component 338 may be used by validator 336, block generator 332, consensus module 334, and/or wallet component 340. Cryptography component 338 may be provide various cryptography services to a node of the distributed ledger. Cryptography component 338 may utilize asymmetric cryptography (aka public-private key cryptography) for digital authentication and/or verification of transactions. Cryptography component 338 may generate cryptographic hashes of data utilizing a common-to-all-nodes hashing algorithm (e.g., SHA256, Scrypt, etc.). In embodiments where the data included in the blocks is sensitive, cryptography component may can encrypt/decrypt data.

In the various embodiments, verification and/or validation of a transactions includes a determination, via a consensus of the nodes, that a reference to a previous state of the document is encoded in the ledger (either in the same block that the transaction will be included in or a previous block of the ledger). As such, a transaction generated via the detection of a transition of a document's state, will include a reference to the previous state of the document (either a reference to another portion of the same block or a reference to a previous block), as well as the fingerprint of the current state and edit history, and any other data to be tracked in the ledger. The reference may point to the previous state's encoded fingerprint, transaction ID, or the like. When a state transition is initiated via a user, the transaction is generated and may be sent to a node. As discussed throughout, at least one node in the ledger would receive the transaction and send along the transaction to other nodes in a ledger network. The node may send along the transaction to other nodes in the ledger network. Upon verification of the transaction via distributed consensus of the nodes, the transaction may be added to the ledger. As indicated throughout, a block in the ledger may store multiple transactions. In some embodiments, a digital signature (enabled via public/private key cryptographs) can be employed, such that only authorized users may add state changes of a document into the ledger.

In some embodiments, image file format 400 may maintain its own ledger of file edits. That is, a ledger is written into image file format that includes blocks encoding distributed ledger data 460 for each of the states of the document. The ledger that is encoded in image file format 400 may be a Blockchain-style ledger. When a new copy of image file format 400 is instantiated and/or the ownership of the file is transitioned, a new fork or branch in the internal ledger may be generated.

### Exemplary Embodiment of a Ledger Analytics Tool

FIG. 5 provides a block diagram 500 that depicts an exemplary ledger analytics tool 500. Ledger analytics server 270 of FIG. 2 may include similar capabilities, functions, and/or components to ledger analytics tool 500. Ledger analytics tool 500 is enabled traverse the distributed ledger, verify/validate the integrity of the contents of ledger, and retrieve and provide any information included in the blocks of the ledger, including but not limited to the edit history of a document. As such, the ledger analytics tool 500 may be able to retrieve and/or recall any state of the document throughout the document's history or lifetime. The ledger analytics tool 500 may provide a complete edit history (or provenance chain) for a document, as well as each state of the document. For example, in embodiments directed towards an image, via the p-hash algorithm described above, a composite image may be analyzed so that subjects included therein are identified and extracted so that a corresponding p-hash is generated for each. Employing ledger analytics tool 500, via traversing the ledger, the p-hash value of a particular subject could be searched to identify, among other things, an original image state and each subsequent image state. Via the user attribution included in the document's edit history, the ledger analytics tool 500 may be employed to identify contributors of composite document, a percentage of attribution associated with user of (or contributor to) the composite document, and determination of copyright owner and/or copyright infringer. For example, a fingerprint based on a tamper resistant image hash function (e.g., a perceptual hash function) may be employed to detect whether two images are similar, even if one of the two images has been modified (e.g., rotated, scaled, or some other transformation) in a way that is detectable via the tamper resistant image hash function. As such, the analytics services may be employed to detect copyright infringement. In addition to image, data, similar methodologies may be employed to detect copyright infringement of audio content. That is, a “perceptual” audio hash function may be employed to detect copyright infringement of audio content. Ledger analytics tool 500 may be a web-based and/or cloud based tool. In at least one embodiment, at least portions of various functionalities of ledger analytics tool 500 may be included in the document editing application 300 of FIG. 3. Ledger analytics tool 500 may be able to retrieve and verify any copy of the document stored in the document repository, as well as any additional information included in the enhanced file format of the document, such as but not limited to image file format 400 of FIG. 4, stored in the document repository. Thus, ledger analytics tool 500 may be a ledger block explorer.

Ledger analytics tool 500 may include one or more of an edit history explorer 502, a subject tracker 504, an ownership tracker 506, an attribution tracker 508, a block traverser 510, and a copyright analyzer 512. Blocker traverser 510 is generally responsible for traversing the blocks of a ledger and extracting and/or retrieving information from the blocks. Block traverser 510 may employ the reference links included in the blocks to traverse the ledger. Graph 520 shows a visual representation of graph tree topology of a bifurcating distributed ledger. The nodes of graph 520 indicate the blocks of the ledger, while the edges of graph 520 indicate the links to the previous block in the ledger. Ledger analytics tool 500 may provide a graphical user interface (GUI) that provides a user with graph 520, as well as the results (i.e., analytics) from any of the analyses performed by ledger analytics tool. To enable their various functionalities, each of edit history explorer 502, subject tracker 504, ownership tracker 508, attribution tracker 508, and copyright analyzer 512 may employ the information retrieved via block traverser 510 traversing the blocks of the ledger.

In various embodiments, graph 520 may be an interactive graph or map. For example, via the GUI, a user may select a node (i.e., a block or record). Upon selection a node of the graph 520, ledger analytics tool may provide any of various analytics and/or information about the document's state corresponding to the records. For example, the edit history associated with block may be provided to the user. A copy of the document for that record may be retrieved from the document repository and provided to the user. For example, the repository copy of the document file format (e.g., image file format 400), for the particular state of the document may be provided to the user. The edit history, up until that selected block, may be provided to the user. In embodiments that are directed towards an image, the image, corresponding to the block, may be displayed to the user.

Edit history explorer 502 is generally responsible for providing a document's edit history to a user. Edit history explorer 502 may reconstruct the entire edit history of the document via block traverse 510 retrieving the delta file history stored in each of the corresponding blocks. In embodiments directed towards an image, subject tracker 504 is generally responsible for tracking the edits to the visual appearance of any of the particular subjects depicted in the image. Thus, subject tracker may reconstruct the provenance of any subject depicted in the image. Any state of the subject, within the evolution of the image, may be recalled, reconstructed, and provided to the user via the semantic segmentation and p-hash embodiments discussed above.

Ownership tracker 506 is generally responsible for tracking the owner of the document. For example, in embodiments where the owner of the document is included in the file format of the document, or when the document owner is tracked in the blocks, an ownership history of the document may be reconstructed and provided to the user. Thus, ownership tracker 506 may generate a chain of title for digital assets. The attribution tracker 508 may track the attributions of different users for different edits and/or attributions to the document. The attributions may be determined via the edit history included in the blocks of the ledger. An overall percentage of a user's contribution to a composite work may be determined based on the user attributions. For example, the user that performed a contribution and/or edit to a document may be tracked via the edit history of the document. The user may be tracked via a user name, or other unique identifier associated with the user. In some embodiments, each user of document editing application 300 may be associated with a unique user name and logon credentials. Each contribution and/or edit to a document written into the edit history may include the user name of the user that is responsible for the contribution and/or edit. The user attributions included in the tracked user history may be employed to determine the overall percentage of each user's contribution.

In one non-limiting example that includes a text-based document (e.g., a journal article) written by two users (e.g., user_A and user_B), via the edit history of the document, attribution tracker 508 determines that user_A has generated and/or edited 70% of the text and user_B has generated and/or edited the remaining 30% of the text. Thus, attribution tracker 508 provides user_A with a 70% attribution for the document and user_B with a 30% attribution for the document. In another non-limiting example that includes an image, the photographer of the image is determined and included as part of the edit history within the ledger. Edits to the image via downstream users of document editing application 300 are tracked via user names of the corresponding users, within the edit history. Thus, attribution tracker 508 is enabled to provide an attribution to the image's photographer, as well as additional users who have provided edits to the image. For example, attribution tracker 508 may determine that used_A is the photographer of an image, while user_B and user_C provided additional edit. In some embodiments, the percentage of the total edits may be attributed to the users. Other variants of attribution for collaborative and/or composite works are possible.

Copyright analyzer 512 may be employed to generate at least a preliminary analysis of any potential copyright infringement issues. The current state of the document, the edits to a document, and any previous state of the document may be analyzed and compared with other documents to determine if content from one document has been copied into the other document. In one non-limiting embodiment, the fingerprint of a first document is compared to a fingerprint of a second document to determine if the second document includes a copy of at least portions of the first document. For instance, in embodiments that include an image, the p-hash values for various objected depicted in an original image may be compared to p-hash values for similar objects depicted in a second image. Similarities between the p-hash values of the original image and the second image may indicate that the second image includes copies of at least some of the objects depicted in the original image. Copyright analyzer 512 may be enabled to perform various analyzes between the fingerprints of multiple documents to determine if one document includes similarities and/or copies of portions of another document. For example, a fingerprint based on a tamper resistant image hash function (e.g., a perceptual hash function) may be employed to detect whether two images are similar, even if one of the two images has been modified (e.g., rotated, scaled, or some other transformation) in a way that is detectable via the tamper resistant image hash function. As such, the analytics services may be employed to detect copyright infringement. In addition to image, data, similar methodologies may be employed to detect copyright infringement of audio content. That is, a “perceptual” audio hash function may be employed to detect copyright infringement of audio content. Copyright analyzer 512 may generate a report indicating such copyright infringements.

### Generalized Processes for Providing Analytic Services to Digital Documents

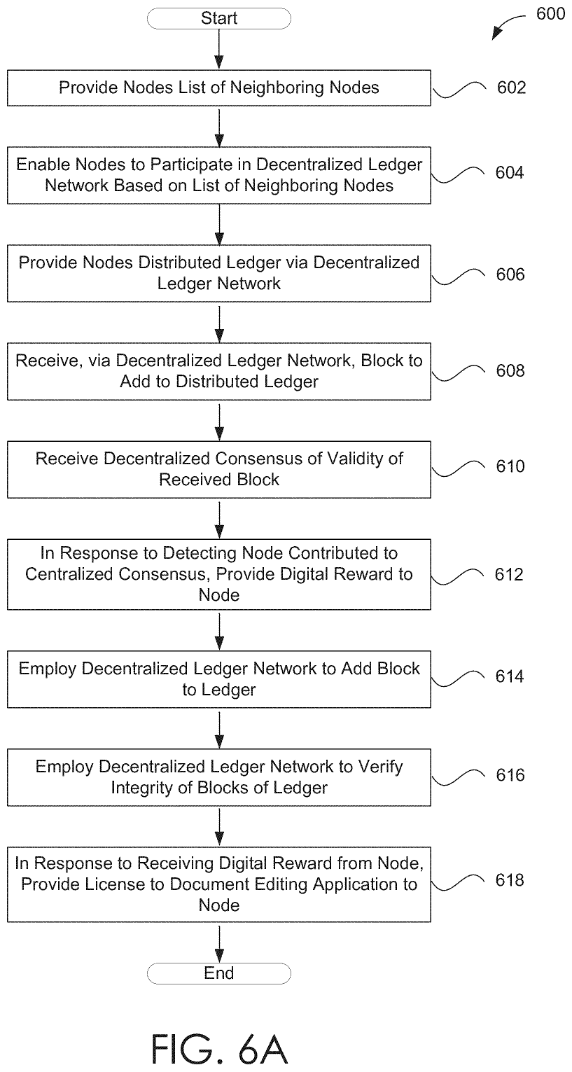

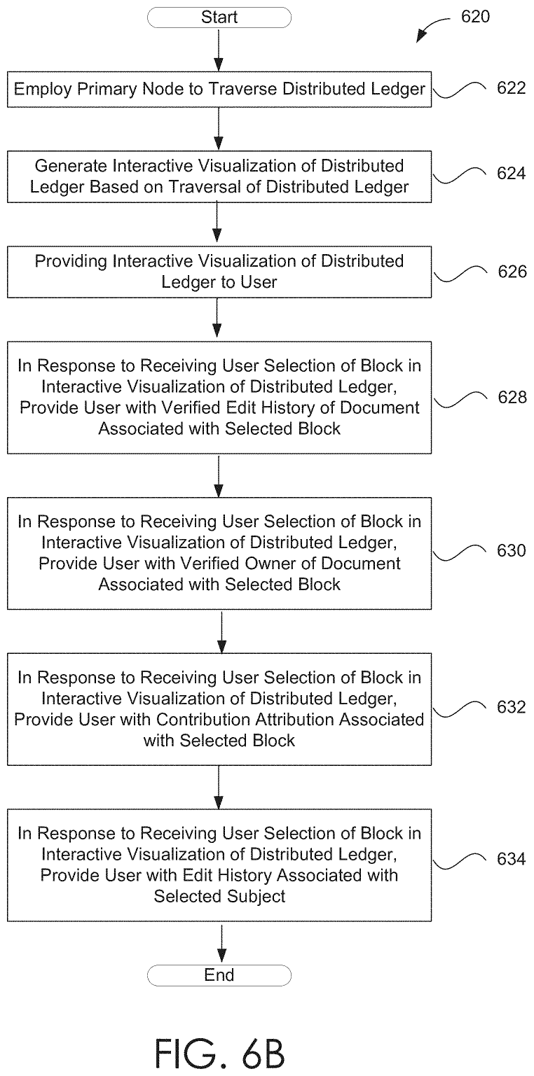

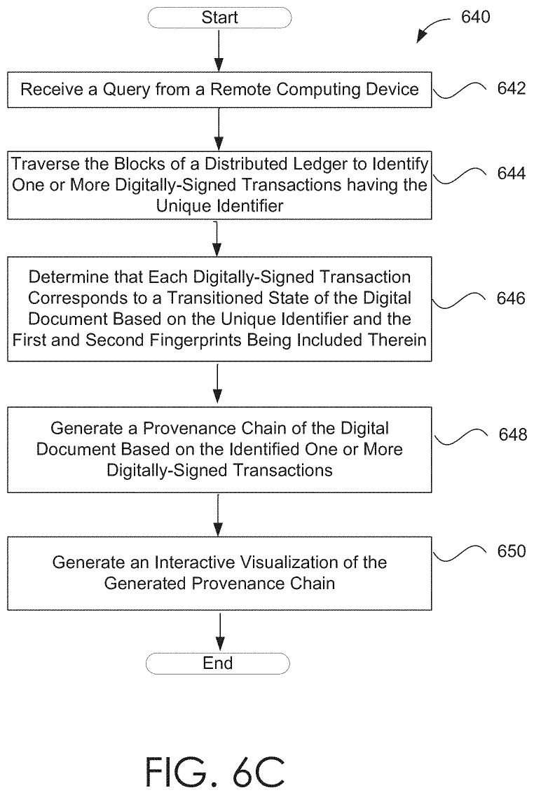

Processes 600, 620, and 640 of FIGS. 6A-6C, or portions thereof, may be performed and/or executed by any computing device, such as but not limited to client devices 230, 230n and server 240 of FIG. 2, as well as computing device 700 of FIG. 7. Additionally, a node, such as but not limited to node 110, 110 of FIGS. 1-2 and/or node component 300 of FIG. 3 may perform and/or execute at least portions of processes 600, 620, and 640. A document editing application, such as but not limited to document editing application 260 of FIG. 2 and/or document editing application 300 of FIG. 3 may perform and/or execute at least portions of processes 600, 620, and 640. Furthermore, a ledger analytics tool, such as but not limited to ledger analytics server 270 of FIG. 2 and/or ledger analytics tool 500 of FIG. 5 may perform and/or execute at least portions of processes 600, 620, and 640.

The discussions of some of the various embodiments of processes 600, 620, and 640 are directed towards providing traceability of an edit history (i.e., a provenance chain) of a digital document that is a digital image. However, it should be understood that the embodiments are not so limited, and various embodiments of processes 600, 620, and 640 may also include providing traceability of an edit history of other types or classes of digital documents and assets, such as but not limited to audio/video recordings, records of transactions, and legal documents.

FIG. 6A illustrates one embodiment of an enhanced process flow for managing various operations associated with a distributed ledger. The distributed ledger may be a blockchain-like distributed ledger. In various embodiments, portions of process 600 may be enabled and/or performed by a primary node and/or one or more other (non-primary) nodes that includes a node component, such as but not limited to node component 330 of FIG. 3. In some embodiments, a primary node may be a primary node of the ledger network. Process 600 begins, after a start block, at block 602, where an image is a listing of neighboring nodes is provided to a plurality of nodes. For example, a primary node may provide a list to each of a plurality of computing devices running a document editing application, such as but not limited to document editing application 260 of FIG. 2 and/or document editing application 300 of FIG. 3. That is, computing devices running and/or implementing the document editing application may provide node services for the maintenance of the distributed ledger, via a node component included in the document editing application, such as but not limited to node component 330. The node component may run as a background process on the computing device, and thus the computing device may provide node services whenever the device is on. For example, the node component may be configured to run as a background process when the document editing application is currently unused. In other embodiments, the node component may only provide node services when the user is actively using the image editing application. Each of the nodes may store at least portions of the distributed ledger. The list provided to a particular node (e.g., particular computing device running the image editing application) may be specifically targeted to the particular computing device, and include a list of other neighboring nodes in their vicinity. In at least one embodiment, the primary node may be operated by an entity or a party that develops and/or publishes the document editing application.

As discussed throughout, in at least some embodiments, the computing device implementing the image editing application does not provide node services. In such embodiments, the image editing application may detect the state transition of the image. In response to detecting the state transition of the image, the image editing application may generate a transaction that includes and/or encodes at least a portion of the data included in distributed ledger data 460 of FIG. 4. The transaction may be provided to the non-primary nodes of the ledger network to be packaged into a block, and the block added to the ledger via a distributed consensus.

At block 604, the primary node may enable the plurality of nodes to participate in a decentralized ledger network that maintains the distributed ledger. For example, the nodes may be enabled, via the node component and the provided lists of neighboring nodes, to self-organize into a peer-to-peer decentralized ledger network. Because the peer-to-peer network is decentralized, the peer-to-peer network may be a distributed ledger network. At block 606, via the decentralized ledger network, the primary node may provide at least a portion of the distributed ledger to one or more of the plurality of nodes. The plurality of nodes may store and maintain various portions of the distributed ledger, via the functionalities of their node component.

At block 608, a block (or record) may be received, via the peer-to-peer network, to add to the distributed ledger. In some embodiments, the block may be received via the primary node. The primary node may provide the other nodes the block. In other embodiments, the nodes distribute the received block to their nearest neighbors within the peer-to-peer network. The received block may be similar to the various embodiments of blocks generated in processes 600 or 700. As discussed throughout, in at least one embodiment, the block may include a fingerprint and/or a cryptographic hash of the contents of a document. At block 610, a decentralized consensus, performed by the nodes, of the validity of the received block, may be received via the peer-to-peer network. For example, the primary node may receive the distributed consensus. A decentralized consensus via the nodes is described throughout. However, briefly here, each of the blocks contributing to and/or participating in the distributed consensus may employ a consensus module, such as but not limited to consensus module 334 of FIG. 3, to perform operations required for the determining of the validity of the block. At block 612, and in response to detecting that a particular node contributed to and/or participated in distributed consensus, regarding the validity of the block, the primary node may encode a transfer of a digital reward (e.g., a digital token of economic value) to the particular node. As discussed throughout, a cryptography component and a wallet component, such as but not limited to cryptography component 338 and wallet component 340 may be employed to transfer the digital token to the particular node.

At block 614, and in response to receiving the distributed consensus, the peer-to-peer network may be employed to store and/or add the block to the distributed ledger. In one embodiment, the primary node coordinates the adding of the validated block to the ledger. At block 616, the peer-to-peer network is employed to verify the integrity of various blocks included in the distributed ledger. For example, one or more nodes may request an audit on the integrity of the data encoded in one or more blocks included in the ledger. As discussed throughout, the, a node may employ a block validator and a cryptography, such but not limited to block validator 336 and cryptography component 338 of FIG. 3, may provide functionalities required to verify the integrity of one or more blocks. For example, the links to previous blocks, as well as the fingerprint of the content of the previous blocks may be employed. At block 618, and in response to receiving a digital award from a node, the primary node may provide at least a temporary license and/or a copy of an application and/or tool, such as but not limited a document editing application and/or a ledger analytics tool.

FIG. 6B illustrates one embodiment of an enhanced process flow for providing various ledger analytics services. Various portions of process 620 may be performed, enabled, and/or implemented by a ledger analytics tool, such as but not limited to ledger analytics server 270 of FIG. 2, ledger analytics client 272 of FIG. 2, and/or ledger analytics tool 500 of FIG. 5. In process 620, a server, such as but not limited to server 240 of FIG. 2, may employ various ledger analytics services to client computing devices, such as but not limited to clients 230, 230n of FIG. 2, via ledger analytics server 270 and corresponding ledger analytics client 272. The ledger analytics server may enable a primary node, while the ledger analytics client may enable a node of a peer-to-peer distributed ledger network. The ledger analytics server and/or tool may be a ledger block explorer. In various embodiments, the ledger analytics tool and/or block explorer is implemented via a primary and/or a master node. Process 620 begins, after a start block, at block 622, where a primary node may be employed to traverse the blocks of a distributed ledger. The distributed ledger may be a blockchain. In some embodiments, the ledger is a bifurcated and/or forked blockchain. In one embodiment, a block traverser, such as but not limited to block traverser 510 may be employed to traverse the blocks (or records) of the distributed ledger. The primary node may be implementing a ledger analytics tool and/or block explorer, such as but not limited to ledger analytics tool 500 of FIG. 5.

At block 624, an interactive visualization of the distributed ledger may be generated based on the block traversal of the distributed ledger. For example, interactive graph 520 of FIG. 5 may be generated. At block 626, the interactive visualization of the distributed ledger may be provided to a user of a client device. The user may be enabled to select one or more nodes (e.g., blocks and/or records) of the visualization of the interactive graph. Based upon the user selection, various ledger analytics services may be provided to the user. At block 628, in response to receiving a user selection of a block in the interactive visualization of the ledger, the user may be provided with a verified and/or validated edit history of the document's state associated with the selected block. At block 630, in response to receiving a user selection of a block in the interactive visualization of the ledger, the user may be provided with a verified and/or validated owner of the document when the document was in the state associated with the selected block. At block 632, in response to receiving a user selection of a block in the interactive visualization of the ledger, the user may be provided with a contribution attribution associated with the document when the document was in the state associated with the selected block. For example, the user may be provided their percentage of contribution to a composite document that has been generated and/or edited by a plurality of users, including the user. At block 624, in response to receiving a user selection of a block in the interactive visualization of the ledger, the user may be provided with a verified and/or validated edit history associated with a particular subject depicted in the document. For example, when the document is an image, a perceptual hash may be employed as a fingerprint of the image. Via tracing the values of the perceptual hash value included in the blocks, an entire edit history of the subject may be provide to the user.

FIG. 6C illustrates another embodiment of an enhanced process flow for providing various ledger analytics services. Various portions of process 640 may be performed, enabled, and/or implemented by a ledger analytics tool, such as but not limited to ledger analytics server 270 of FIG. 2, ledger analytics client 272 of FIG. 2, and/or ledger analytics tool 500 of FIG. 5. In process 640, a server, such as but not limited to server 240 of FIG. 2, may employ various ledger analytics services to client computing devices, such as but not limited to clients 230, 230n of FIG. 2, via ledger analytics server 270 and corresponding ledger analytics client 272. The ledger analytics server may enable a primary node, while the ledger analytics client may enable a node of a peer-to-peer distributed ledger network. The ledger analytics server and/or tool may be a ledger block explorer. In various embodiments, the ledger analytics tool and/or block explorer is implemented via a server, or primary and/or a master node.

Process 640 begins, after a start block, at block 642, where a primary node can receive a query from a remote computing device, such as any of clients 230n of FIG. 2. The query can include, among other things, a unique identifier associated with a digital document. In various embodiments, the unique identifier can include a file name, a hash of the file name, a unique identifier generated for the digital document (e.g., upon its initial creation or storage to a memory), among other things.

At block 644, the primary node can traverse the blocks of a distributed ledger to identify one or more digitally-signed transactions, stored thereon, having the unique identifier included therein. In various embodiments, the distributed ledger may be a blockchain, and a digitally-signed transaction having the unique identifier stored on the blockchain may correspond to a transitioned state of the digital document. In some further embodiments, each digitally-signed transaction having the unique identifier stored therein can also include at least a first digital fingerprint (e.g., a hash) and a second digital fingerprint (e.g., a hash). The first digital fingerprint can correspond to a first transitioned state of the digital document, and the second digital fingerprint can correspond to a second transitioned state of the digital document. In other words, the first digital fingerprint can include a hash of the digital document in a state at which a change or modification to the digital document was determined. Further, the second digital fingerprint can include a hash of the digital document in a state at which the digital document was in prior to the change or modification. As described herein, a document editing application, such as document editing application 260 of FIG. 2, can determine when modifications to a digital document are made, and further generate hashes corresponding to various states thereof. In some embodiments, the distributed ledger is a bifurcated and/or forked blockchain. In one embodiment, a block traverser, such as but not limited to block traverser 510, may be employed to traverse the blocks (or records) of the distributed ledger to identify the one or more digitally-signed transactions having the unique identifier included therein. The primary node may implement a ledger analytics tool and/or block explorer, such as but not limited to ledger analytics tool 500 of FIG. 5.

At block 646, the primary node can determine, from the identified one or more digitally-signed transactions, that each digitally-signed transaction corresponds to a transitioned state of the digital document based on the unique identifier and the first and second fingerprints being included therein. Among other things, the plurality of digitally-signed transactions can include a first digitally-signed transaction corresponding to a first transitioned state of the digital document and a second digitally-signed transaction corresponding to a second transitioned state of the digital document. In some aspects, a digitally-signed transaction can be generated (e.g., by document editing application 260 of FIG. 2) at a time that corresponds to a determined modification or change to the digital document. As described herein, the time can correspond to when the digital document is saved in a memory, or when a computing device (e.g., client 230n of FIG. 2) having document editing application 260 executing thereon determines that a modification or change was made to the digital document. In some embodiments, a timestamp corresponding to a time of a determined modification can also be included and/or associated with a fingerprint included in a transaction. In this regard, a transaction may include a first and second fingerprint, having a first and second timestamp, respectively.

At block 648, the primary node can generate a provenance chain of the digital document based on the identified one or more digitally-signed transactions. More specifically, the primary node can order and/or connect the identified one or more transactions to depict a version history of the digital document. Among other things, the generated provenance chain can include the first transaction, followed by (e.g., connected to) the second transaction, based on a determination that the second fingerprint of the second transaction corresponds to the first fingerprint of the first transaction.

By way of example, when a digital document is saved on a client device (e.g., via document editing application 260 of FIG. 2), a first transaction can be generated that includes a first hash that is generated and corresponds to the current (“modified” or “transitioned”) state of the digital document, and a second hash of the digital document that was generated and corresponds to a prior (“unmodified” or “non-transitioned”) state of the digital document. The generated first transaction can be digitally-signed with a private key associated with the client device, whereby the private key is associated with a user of the client device. In this regard, digitally-signed transactions having been signed with the private key are employable to determine a user associated with modifications made to the digital document. If the digital document is later modified, whether on the client device or on another client device (e.g., also via document editing application 260 of FIG. 2), a second transaction can be generated that includes a first hash that is generated and corresponds to the current (“modified” or “transitioned”) state of the digital document, and a second hash of the digital document that was generated and corresponds to a prior (“unmodified” or “non-transitioned”) state of the digital document. Similarly, the generated second transaction can be digitally-signed with a private key associated with the client device or other client device, whereby the private key is associated with a user of the client device or other client device. As described herein, each digitally-signed transaction is stored on a blockchain based on communications of the digitally-signed transactions from the client(s) to nodes, such as nodes 110 of FIG. 2, configured to maintain the distributed ledger. Provided the foregoing, the primary node can determine that the second hash of the second digitally-signed transaction corresponds to the first hash of the first digitally-signed transaction. The matching of these hashes is indicative of a direct correlation between two states of the digital document. In other words, there were no additional changes between the two different versions of the digital document as represented by the first and second digitally-signed transactions. The primary node can thus generate a transactional tree that represents a chain of provenance throughout the entire lifecycle of the digital document.

At block 650, an interactive visualization of the generated provenance chain may be generated. For example, a visual representation of a transactional tree, similar to interactive graph 520 depicted in FIG. 5 may be generated. At block 650, the interactive visualization of the distributed ledger may be provided to the remote computing device from which the query (i.e., the unique identifier) was received. The remote computing device may be enabled to select one or more nodes (e.g., blocks and/or records) of the provided interactive visualization. Based upon a selection received from the remote computing device, various ledger analytics services may be provided by the primary node to the user. In some embodiments, responsive to receiving a selection of a block in the interactive visualization of the ledger, the primary node can provide the remote client device with a verified and/or validated edit history of the document's state associated with the selected block. In another embodiment, the primary node can provide the remote client device with a verified and/or validated owner of the document when the document was in the state associated with the selected block. In another embodiment, the primary node can provide the remote client device with a contribution attribution associated with the document when the document was in the state associated with the selected block. In another embodiment, the primary node can provide the remote client device with a verified and/or validated edit history associated with a particular subject depicted in the document. For example, when the document is an image, a perceptual hash may be employed as a fingerprint of the image. Via tracing the values of the perceptual hash value included in the blocks, an entire edit history of the subject may be provided to the remote computing device.

### Additional Embodiments for Tracking Edits to a Digital Document

Additional and/or alternative embodiments for tracking edits to a digital document and/or digital asset will now be described. These embodiments are consistent with the various embodiments described herein. As such, the document may be, but is not limited to, an image, audio/video recording, textual-based documents, spreadsheet documents, slide-deck documents, software source code, various records of economic and/or legal transactions, as well as various works of scholarship, art, and/or entertainment encoded in digital documents. In some embodiments, a method includes, in response to detecting a transition from a previous state of an image to a current state of a document, a current fingerprint of the image, which corresponds to the current state of the document, is generated. The document may be, but is not limited to, an image. A transaction may be generated. The generated transaction may include and/or encode the generated current fingerprint. The transaction may also include a unique identifier of the document. The unique identifier may include a document identification number, file name, file path, file address, or a reference or link to the document. The transaction may be signed via a private key of the computing device. The transaction may be communication to a plurality of nodes that collectively maintains a distributed ledger. The signed transaction may be communicated to at least one of the nodes such that the plurality of nodes may store the transaction in a current block of the distributed ledger.

That is, the current block may be added to a distributed blockchain-like ledger. The current block may include at least one of the current fingerprint of the image, a reference to a previous block included in the distributed ledger, or a fingerprint of the previous block. The previous block may encode a previous transaction that includes a previous fingerprint of the image that corresponds to the previous state of the image.

In some embodiments, the methods includes generating (or at least causing the generating of) an updated edit history of the image. The updated edit history indicates visual edits applied to the previous state of the image. The current state of the image includes the one or more visual edits. The transaction encoded in the current block may include the updated edit history of the image. The previous block may encode a previous transaction that includes a previous edit history of the image.

A copy of the image may be stored in an image repository. The copy of the image is in the current state. The current block may include a reference to the stored copy of the image. In response to a user request, the reference to the stored copy of the image may be accessed. In response to detecting the transition from the previous state of the image to the current state of the image, structured data that encodes the image may be updated to include the current fingerprint of the image, an updated edit history of the image, the reference to the previous block, the previous fingerprint of the image, and a reference to a repository copy of the image. The repository copy of the image may be in the current state.

The previous block may be included in a first branch of the distributed ledger that tracks image edits associated with a first user. In response to determining that a second user has been provided a copy of the image, the current block may be added to a second branch in the distributed ledger. The second branch may track image edits associated with the second user. Generating the current fingerprint of the image may include generating a cryptographic hash value of at least a portion of the image. In one embodiment, a subject (e.g., an object) is detected in the image. A perceptual hashing algorithm is employed to determine a perceptual hash value of a region of the image that depicts the subject. The perceptual hash value may include and/or may be the current fingerprint of the image.

In another embodiment, a document is generated. For example, an image may be captured via a camera. A first cryptographic hash value of at least a portion of the document is stored in a distributed ledger that is at least similar to a blockchain. The camera may at least generate the first cryptographic hash. A state transition of the document is detected. In response to detecting the state transition of the document, a second cryptographic hash of the document is generated. The second cryptographic hash of the document is stored in the blockchain. In response to detecting the state transition of the document, an edit history of the document is generated and/or updated. The edit history of the document is stored in the blockchain. A copy of the document may be stored in a document repository. A reference link to the copy of the document may be stored in the blockchain. The reference link stored in the blockchain may be employed to provide the copy of the document to a user.

Metadata associated with the document may be stored in the blockchain. A file format for the document may store the metadata and a fingerprint for the document. The fingerprint may include at least one of the first and/or the second cryptographic hash of the document. In response to detecting a distribution of the document to one or more users, a bifurcation or fork in the blockchain may be generated. Regions in the image that depict one or more subjects may be identified and/or detected. A perceptual hash value of each of the identified regions in the image is generated. The first cryptographic hash value includes the perceptual hash value for each of the identified regions in the image. The perceptual hash value for each of the identified regions is a fingerprint for the corresponding subject depicted in the region.

In another embodiment, in response to detecting an operation on a document file, a fingerprint of the document is generated. In some embodiments, the document may be an image and the document file may be an image file that includes image data encoding an image, wherein the image file includes image data encoding the image and the fingerprint is based on at least a portion of the image data. A record (or block) that includes the fingerprint (e.g., a cryptographic hash value) of the image is generated. The record is provided to a plurality of nodes of a distributed ledger. The distributed ledger may include a plurality of other records and may be a blockchain. A consensus of a validity of the record is received from at least a portion of the plurality of nodes. In response to receiving the consensus of the validity of the record, the record is added to and/or stored in a distributed ledger. The added record includes a first reference link to a first record of the plurality of other records and a first hash value based on the first record. The added record may further include an updated edit history of the image. The first record may include a previous edit history of the image. The first hash value may be further based on the previous edit history of the image.

In some embodiments, and in response to detecting an operation on an image file, a copy of the image file may be provided to an image repository. A second reference link may be in the added record. The second reference link may be a reference link to the copy of the image file. The first record includes a third reference link to a previous copy of the image that is stored in the image repository. The first hash value is further based on the third reference link. The second reference link may be accessed via the added record. The accessed second reference link is employed to retrieve the copy of the image file. Another fingerprint of the image that is based on the retrieved copy of the image file may be generated. An integrity of the retrieved copy of the image may be determined via a comparison between the fingerprint of the imaged included in the added record and the other fingerprint of the image.

In various embodiments, the image file is updated to include the fingerprint of the image, the first reference link to the first record, and the first hash value. The distributed ledger may include a bifurcated topology. The bifurcated topology may include a plurality of branches. Each of the plurality of branches may be associated with a separate version of the image. The fingerprint of the image may be further based on applying a perceptual hashing algorithm to a portion of the image data. The portion of the image data depicts a particular subject of a plurality of subjected depicted by an entirety of the image data.

In various embodiments directed towards maintaining a distributed ledger across a plurality of nodes, a primary node is employed to provide each of the plurality of nodes with a corresponding list of neighboring nodes of the plurality of nodes. The plurality of nodes are enabled to self-organize into a peer-to-peer network based on the provided lists of neighboring nodes. Via the peer-to-peer network, at least a portion of the distributed ledger is provided to each of the plurality of nodes. In response to receiving a consensus on a validity of a block from the plurality of nodes, the peer-to-peer network may be employed to store the block in the distributed ledger. The block may include a fingerprint of at least a portion of an image. Each of the plurality of nodes may be at least partially implemented by a node component. The node component may be included in an image editing application that is configured to edit the image. In some embodiments, the node component is configured to run as a background process when the image editing application is currently unused. In other embodiments, the node component is configured to run only when the image editing application is currently in use.

In some embodiments, and in response to detecting that a first node of the plurality of nodes contributed to the consensus on the validity of the block, a transfer of a digital token, from the primary node to the first node, may be encoded in the distributed ledger. In another embodiment and in response to receiving, from a first node of the plurality of nodes, a transfer of a digital token, the first node may be provided with a license to and/or a copy of an image editing application. The license may be a time-limited license or a perpetual license.

In one embodiment, a portion of the plurality of nodes is provided a plurality of analytics services associated with a provenance chain of the image. The plurality of analytics services may include at least one of identification of transfer of ownership of the image or verifying an edit history of the image that is stored in the distributed ledger.

In still another embodiment, a method includes employing a service provider to retrieve a first block included in a distributed ledger. The service provider may be a ledger analytics tool. The first block includes a first fingerprint of the document that corresponds to a first state of the document. The service provider is employed to access a second fingerprint of the document that corresponds to a second state of the document. In some embodiments, accessing the second fingerprint may include generating the second fingerprint. In other embodiments, accessing the second fingerprint may include retrieving a second block in the distributed ledger that includes the second fingerprint and is associated with the second state of the document. The service provider is employed to generate a comparison between the first fingerprint of the document and the second fingerprint of the document. For example, the service provider may analyze each of the first and the second fingerprints. Based on the comparison, the service provider may identify a difference between the first fingerprint of the document and the second fingerprint of the document via the comparison. In response to identifying the difference, an indication that the second state of the document includes one or more edits that are not included in the first state of the document may be generated and provided to a user.

In some embodiments, the document is an image. The first fingerprint of the document may include a first perceptual hash (p-hash) value of at least a first portion of the image in the first state. The second fingerprint of the document includes a second p-hash value of the first portion of the image in the second state. The first and the second p-hash values may be p-hash values of a particular subject depicted in the image. The service provider may be implemented by a primary node of a ledger network that maintains the distributed ledger. In some embodiments, the service provider may be to generate the visualization of the distributed ledger. The visualization of the distributed ledger may be provided to a user.

In various embodiments, generating the comparison between the first fingerprint of the document and the second fingerprint of the document may include identifying one or more similarities between the first fingerprint of the document and the second fingerprint of the document via the comparison. In response to identifying the one or more similarities between the first fingerprint of the document and the second fingerprint of the document via the comparison, an indication that the second state of the document includes a copy of one or more portions of the first state of the document may be generated. In at least one embodiment, the service provider is employed to determine a first contribution to the document that is associated with a first user. The service provider is also employed to determine a second contribution to the document that is associated with the second user. The service provider is employed to an indication of the first and second contributions to the document.

### Exemplary Embodiment of a Computing Device

Having described embodiments of the present invention, an exemplary operating environment in which embodiments of the present invention may be implemented is described below in order to provide a general context for various aspects of the present invention. Referring initially to FIG. 7 in particular, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes a bus 710 that directly or indirectly couples the following devices: memory 712, one or more processors 714, one or more presentation components 716, input/output (I/O) ports 718, input/output components 720, and an illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterates that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer-storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be equipped with depth cameras, such as stereoscopic camera systems, infrared camera systems, RGB camera systems, touchscreen technology, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

As can be understood, embodiments of the present invention provide for, among other things, traceability of edits to and a provenance chain for digital documents and/or assets via a distributed ledger, such as but not limited to a blockchain-style ledger. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A non-transitory computer-readable storage medium having instructions stored thereon for providing analytics services for a distributed ledger, which, when executed by a processor of a computing device cause the computing device to perform actions comprising:
receiving a unique identifier associated with a digital document;
determining, based on the received unique identifier, that the distributed ledger includes a first digitally-signed transaction corresponding to a first transitioned state of the digital document and a second digitally-signed transaction corresponding to a second transitioned state of the digital document, wherein each digitally-signed transaction includes a first fingerprint corresponding to a transitioned state of the digital document and a second fingerprint corresponding to a prior state of the digital document; and
generating a provenance chain of the digital document including the first transaction followed by the second transaction based on a determination that the second fingerprint of the second transaction corresponds to the first fingerprint of the first transaction.

2. The computer-readable storage medium of claim 1, wherein the digital document is an image, the first fingerprint of the document includes a first tamper resistant image hash value of at least a portion of the image in the first state, and the second fingerprint of the document includes a second tamper resistant image hash value of at least the portion of the image in the second state.

3. The computer-readable storage medium of claim 2, wherein the first and the second tamper resistant image hash values are perceptual hash values corresponding to a particular subject that is depicted in at least the portion of the image.

4. The computer-readable storage medium of claim 1, wherein the provenance chain corresponds to a version history of the digital document.

5. The one or more computer-readable storage media of claim 1, wherein the actions further comprise:
generating a visualization of the generated provenance chain; and
providing the visualization of the generated provenance chain to a client device from which the unique identifier was received.

6. The one or more computer-readable storage media of claim 1, wherein generating the provenance chain of the digital document includes forming a transactional tree that includes a plurality of digitally-signed transactions corresponding to transitioned states of the digital document, each digitally-signed transaction being connected to at least one other digitally-signed transaction based on the second fingerprint of the digitally-signed transaction corresponding to the first fingerprint of another digitally-signed transaction.

7. The one or more computer-readable storage media of claim 1, wherein each transaction is digitally-signed with a private key of a user associated with the transitioned state of the digital document, the digitally-signed transaction being employable to determine the user associated with the transitioned state.

8. A computer-implemented method for providing analytics services for a distributed ledger, comprising:
receiving, by a computing device, a unique identifier associated with a digital document from a remote computing device;
based on the received unique identifier, determining, by the computing device, that the distributed ledger includes a first transaction corresponding to a first transitioned state of the digital document and a second transaction corresponding to a second transitioned state of the digital document, wherein each transaction includes the unique identifier, a first fingerprint of the digital document generated at a first time of a transitioned state, and a second fingerprint of the digital document generated at a second time of a previously transitioned state;
generating, by the computing device, a provenance chain of the digital document including the first transaction followed by the second transaction based on a determination that the second fingerprint of the second transaction corresponds to the first fingerprint of the first transaction; and
generating, by the computing device, a visualization of the generated provenance chain.

9. The computer-implemented method of claim 8, wherein the document is an image, the first fingerprint of the document includes a first tamper resistant image hash value of at least a portion of the image in the revised state, and the second fingerprint of the document includes a second tamper resistant image hash value of at least the portion of the image in the previous state.

10. The computer-implemented method of claim 9, wherein the first and the second tamper resistant image hash values are perceptual hash values corresponding to a particular subject that is depicted in at least the portion of the image.

11. The computer-implemented method of claim 8, wherein the provenance chain corresponds to a version history of the digital document.

12. The computer-implemented method of claim 8, wherein the first fingerprint of the digital document was generated by a document editing application and communicated to a distributed ledger network configured to maintain the distributed ledger.

13. The computer-implemented method of claim 8, further comprising providing, by the computing device, the generated visualization to the remote computing device as a response to the received unique identifier.

14. The computer-implemented method of claim 13, further comprising:
determining, by the computing device, a first contribution to the digital document that is associated with a first user;
determining, by the computing device, a second contribution to the digital document that is associated with a second user; and
generating, by the computing device, an indication corresponding to the determined first and the second contributions for inclusion in the generated visualization.

15. A system comprising:
a block traversing means for determining, based on a received unique identifier, that a distributed ledger includes a first digitally-signed transaction corresponding to a first transitioned state of the digital document and a second digitally-signed transaction corresponding to a second transitioned state of the digital document, wherein each of a plurality of digitally-signed transactions stored on the distributed ledger includes the unique identifier, a first fingerprint of the digital document generated at a first time of a transitioned state, and a second fingerprint of the digital document generated at a second time of a previously transitioned state; and
an analytics means for generating a provenance chain of the digital document including the first transaction and the second transaction based on an association of at least one fingerprint of the first transaction and at least one fingerprint of the second transaction.

16. The system of claim 15, further comprising:
an ownership tracking component for generating a chain of title associated with the digital document based on an extracted document ownership history further included in each transaction of the plurality of digitally-signed transactions.

17. The system of claim 15, wherein each transaction of the plurality of digitally-signed transactions includes an edit history corresponding to modifications of the previously transitioned state to the transitioned state, the transaction being digitally-signed with a private key of a user associated with the modifications,
the system further comprising:
an attribution tracking component for generating, based on the included edit history and a digital signature of each transaction, a percentage of contribution for each user in a set of users for the digital document.

18. The system of claim 15, further comprising:
a copyright analyzing component for comparing at least one of the first and second fingerprints of the digital document to at least one of another first fingerprint and another second fingerprint of a different digital document to determine that at least a portion of the digital document corresponds to at least another portion of the different digital document.

19. The system of claim 15, wherein the analytics means further provides, to a computing device from which the unique identifier was received, a generated visual representation of the generated provenance chain.

20. The system of claim 15, wherein the generated provenance chain includes a set of digitally-signed transactions corresponding to transitioned states of the digital document, each digitally-signed transaction being connected to at least one other digitally-signed transaction based on the second fingerprint of the digitally-signed transaction corresponding to the first fingerprint of another digitally-signed transaction.
